(19) United States
(12) Patent Application Publication
(10) Pub. No.: US 2007/0152074 A1
(43) Pub. Date: Jul. 5, 2007

(54) ELECTRONIC KITCHEN DISPENSING FAUCET

(75) Inventors: Elliott V. Stowe, Stevensville, MI (US); Richard R. Blake, Sawyer, MI (US); Paul J. Gray, South Bend, IN (US); Thomas J. Newhouse, Grand Rapids, MI (US); Michael A. Bergeron, Pineville, LA (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Edgewater Faucet LLC

(21) Appl. No.: 11/684,928

(22) Filed: Mar. 12, 2007

Related U.S. Application Data
(63) Continuation-in-part of application No. 11/023,240, filed on Dec. 27, 2004, now Pat. No. 7,151,084.
(60) Provisional application No. 60/782,335, filed on Mar. 14, 2006.
(60) Provisional application No. 60/791,352, filed on Apr. 12, 2006.

(51) Int. Cl. G05D 23/13; B67D 5/08; B67D 5/16

(52) U.S. Cl. 236/12.1; 222/71; 222/56

(57) ABSTRACT

An electronic kitchen faucet dispensing apparatus capable of dispensing measured operator-selectable quantities of hot or cold liquid into a container with a flow rate suitable to prevent splashing and loss of the ensuing mixture while maintaining a rapid flow rate to quickly fill larger containers. The dispensing faucet can be used for measuring liquids required for preparing recipes, making instant beverages, or in the preparation of pre-packaged foods, and may be retrofitted to an existing faucet. The apparatus may utilize various controls to automatically control liquid flow, including 1) flow sensors and control valving; 2) positive-displacement pumps; and 3) flow-restrictors with shut-off valves. Also, it can be connected to a garbage disposal to prevent damage to the disposal.

### CROSS REFERENCE TO RELATED APPLICATION

This application is a continuation-in-part of application Ser. No. 11/023,740, filed Dec. 28, 2004, entitled ELECTRONIC KITCHEN DISPENSING FAUCET. This application also claims benefit of provisional application Ser. No. 60/782,335, filed Mar. 14, 2006, entitled ELECTRONIC KITCHEN DISPENSING FAUCET, and also claims benefit of provisional application Ser. No. 60/791,352, filed Apr. 12, 2006, entitled ELECTRONIC KITCHEN DISPENSING FAUCET. The entire content of each of the above applications is incorporated herein by reference in their entirety.

### BACKGROUND OF THE INVENTION

The present invention relates to liquid measuring and dispensing devices, and more particularly relates to devices for accurate and easy dispensing of adjustable amounts of liquid and/or at adjustable desired temperatures.

Liquid measuring and dispensing devices exist for use in industrial applications and beverage dispensing devices. An industrial dispenser is typically set up or calibrated for dispensing a consistent volume of liquid and is operated in repetitive batch mode. The calibrated settings may be stored in the industrial dispenser and used again at a later time for consistently producing the same product. However, these devices are not sufficiently accurate for small volumes that are desired in many kitchens, nor are they sufficiently controlled for accurate temperatures as needed in many kitchens, especially consumer kitchens where recipes are relatively small.

Thus, there is a need to improve the accuracy and ease of dispensing liquids in industrial, commercial, and consumer kitchens while preparing recipes and pre-packaged food products. Further, known liquid-dispensing devices are not configured to be conveniently located within smaller kitchens and do allow for dispensing precise volumes of liquid, or more specifically water, into a container for reconstituting pre-packaged food or mixing with other recipe ingredients.

Still further, known systems are not configured to automatically adjust the flow rate of liquid based on the volume of liquid to be dispensed. This automatic adjustment of the flow rate is necessary to compensate for the anticipated container size and will prevent the ensuing mixture from gushing out of the container when the liquid is added.

Still further, known liquid-dispensing devices cannot accurately dispense a precise volume of liquid at specific temperatures. One such example would be for activating yeast for use in baking. Yeast requires a specific volume of liquid at a very narrow temperature range to effectively promote the yeast to produce carbon dioxide necessary for proper rising of flour during baking. If the liquid is too hot, the yeast is instantly killed. If the liquid is too cool, the yeast will cake or not produce sufficient quantities of carbon dioxide for proper rising.

There are many additional needs not presently met in the industry. For example, there is also a need for accurately dispensing an exact volume of water at extremely elevated temperatures as required when mixing beverages like coffee, tea, or cocoa. Likewise, there is a need for the apparatus to limit the volume of extremely hot liquid that is dispensed in a single dispensing cycle to prevent overflowing the container and to prevent scalding of the operator.

There is a need to allow normal or manual operation of a “standard” kitchen faucet. Numerous other kitchen tasks require the use of the faucet to dispense liquid at varying flow rates and temperatures. These include tasks such as washing pots, pans, and utensils or rinsing food during preparation of recipes. These tasks require the operator to manually adjust the liquid flow rate and temperature for the task undertaken. There is a further desire by the commercial or consumer chef for the kitchen faucet to be quickly converted to allow dispensing of precise volumes, temperature, and flow rates of liquids.

There is a need for the kitchen faucet to control a garbage disposal unit. As the kitchen faucet senses liquid flowing, the garbage disposal may be operated by the operator. Should the kitchen faucet not have sufficient liquid flowing, the garbage disposal unit would not operate, even when requested by the operator.

Furthermore, there is a need for a kitchen faucet that disables or turns off the garbage disposal when the flow of liquid from the kitchen faucet is stopped. This prevents damage to the garbage disposal when insufficient liquid is flowing.

While some manufacturers have attempted to solve the dispensing of specific volumes of liquid for industrial baking or processing, known devices are typically too big and cumbersome to be retrofitted to a commercial or consumer kitchen sink. One such device is available from Hass Manufacturing Company and sold under the product name of Intellifaucet BC375 Batch Controller. While this device may be useful for dispensing a large volume of liquid for batch processing, it is inadequate for dispensing small volumes of liquid and/or for dispensing precise volumes of liquid, which items are needed in preparing recipes in the commercial or consumer kitchen.

Other products like the one shown in U.S. Pat. No. 5,431,302 entitled Dispensing Liquid Volume Control by Tulley et al. describes a specialty dispenser for dispensing beer or other expensive carbonated beverages. This apparatus improves the volumetric accuracy by compensating for the liquid spilled from the container. This spillage compensation method would not work for kitchen recipes or food preparation. If used in preparing cooking recipes or other food preparation, the results would be disastrous as the outcome of the recipe would be compromised by the spillage of the liquid and the ensuing mixture.

Therefore, there exists a need, both for households and restaurants, and also for consumers and chefs, a device configured to accurately measure and dispense water or other liquids in the kitchen for use in preparing recipes, while making instant hot or cold beverages, or in the preparation of pre-packaged foods. There is also a need for flexibility of use to satisfy the wide variety of needs in such applications.

Accordingly, a kitchen dispensing faucet apparatus is desired that provides the advantages noted above and that solves the disadvantages.

### SUMMARY OF THE INVENTION

The present invention relates to an apparatus and method for accurately dispensing an operator-selected volume of liquid from a kitchen faucet for use in preparing food recipes or general food preparation. In another aspect, the present invention relates to an apparatus and method for dispensing liquids at accurate selected temperatures. In still another aspect, the present invention relates to an apparatus and method for controlling a garbage disposal based on the flow of water through a faucet while performing food preparation.

In one aspect of the present invention, a liquid-dispensing apparatus includes a first circuit adapted for connection to a first source of liquid to dispense liquid from the first source at a first flow rate, the first circuit including a first valve for controlling the flow of the liquid from the first source through the first circuit. The apparatus further includes a second circuit also adapted for connection to the first source of liquid and being constructed to dispense liquid from the first source at a second flow rate different than the first flow rate, the second circuit including a second valve for controlling the flow of the liquid from the first source through the second circuit. At least one flow meter is provided for measuring the volume of the liquid dispensed through the first and second circuits. A programmable controller is operably connected to at least one flow meter and to the first and second valves, the controller being programmed and adapted to receive first signals from the at least one flow meter and being programmed and adapted to generate second signals to control the first and second valves to dispense a variable amount and also an accurate total amount of dispensed liquid.

In another aspect of the present invention, a kitchen faucet apparatus adapted to dispense a selected amount of liquid includes a base, a faucet supported on the base, a first circuit having a first flow rate and adapted to connection to a source of liquid, and a second circuit having a second flow rate and adapted to connection to a source of liquid. The first and second circuits are connected to the faucet and include valves for controlling the first and second flow rates to accurately deliver a total flow amount of as little as ½ teaspoon and as great as at least 1 gallon. A controller is programmed to variably control the flow-controlling devices of the first and second circuits to output a selected quantity of liquid.

In yet another aspect of the present invention, a liquid-dispensing apparatus includes a first circuit adapted for connection to a first source of liquid to dispense liquid from the first source at a variable flow rate, the first circuit including at least one variable-rate device for automatically controlling the flow of the liquid from the first source through the first circuit. A programmable controller is operably connected to the variable-flow-rate device and being programmed and adapted to generate signals to control the variable-flow-rate device to dispense an accurate total amount of dispensed liquid down to within at least 10% of a ½ teaspoon of liquid.

In another aspect of the present invention, a kitchen faucet apparatus adapted to dispense a selected amount of liquid includes a base, a faucet supported on the base, and a circuit having a flow rate of at least 0.5 gallons per minute and adapted to connection to a source of liquid. The circuit is connected to the faucet and includes a variable-flow-rate device for controlling the flow rate to accurately deliver a total flow amount of as little as ½ teaspoon and as great as at least 1 gallon.

In another aspect of the present invention, a kitchen faucet apparatus adapted to dispense a selected amount of liquid includes a base with an input device, and an outlet with a faucet supported on the base and including a temperature sensor. First and second circuits are connected to first and second sources of liquid at different temperatures, respectively, and include first and second variable-flow-rate control devices; the first and second circuits being connected to the outlet. A controller is operably connected to the input device, to the sensor and to the first and second variable-flow-rate control devices; the controller being programmed to output a selected quantity of liquid at a selected temperature.

An object of the invention is to provide a liquid-dispensing apparatus comprising a base adapted for mounting to a kitchen sink. A spout extends from the base for dispensing the total amount of liquid. A first circuit is constructed and adapted for connection to a first source of liquid. The first circuit includes a valve to control the flow of liquid from the first source through the circuit. A first flow meter is adapted to measure the volume of the first source liquid flowing through the liquid-dispensing apparatus. A programmable controller is operably connected to the first flow meter and to the first valve contained within the first circuit. The programmable controller is adapted to receive first signals from the flow meter representing the volume of liquid flowing through the meter and dispensed from the liquid-dispensing apparatus. The programmable controller also is adapted to generate second signals to control the first valve to dispense an accurate total amount of dispensed liquid from the spout.

Another object of the invention is to provide a liquid-dispensing apparatus comprising a first and second circuit constructed and adapted for connection to a first source of liquid. The first and second circuits each include a valve to control the flow of liquid from the first source through their respective circuit. A first flow meter is adapted to measure the volume of the first source liquid flowing through the liquid-dispensing apparatus. A programmable controller is operably connected to the first flow meter and to the first and second valves contained within the first and second circuits. The programmable controller is adapted to receive first signals from the flow meter representing the volume of liquid flowing through the meter and dispensed from the liquid-dispensing apparatus. The programmable controller also is adapted to generate second signals to control the first and second valves to dispense an accurate total amount of dispensed liquid.

Another object of the invention is to provide a liquid-dispensing apparatus comprising a base adapted for mounting to a kitchen sink. A spout extends from the base for dispensing the total amount of liquid. A first circuit is constructed and adapted for connection to a first source of liquid. The first circuit includes a positive-displacement pump to control the flow of liquid from the first source through the circuit. The first positive-displacement pump is capable of measuring the volume of the first source liquid flowing through the liquid-dispensing apparatus. A programmable controller is operably connected to the first positive-displacement pump within the first circuit. The programmable controller is adapted to provide first signals to the positive-displacement pump representing the volume of liquid flowing through the positive-displacement pump and dispensed from the liquid-dispensing apparatus.

Another object of the invention is to provide a liquid-dispensing apparatus comprising a positive-displacement pump connected to a variable-speed control device. The variable-speed control device provides the means of changing the flow rate of the first source of liquid through the device. It is therefore an object of the invention to provide a liquid-dispensing apparatus comprising a base adapted for mounting to a kitchen sink. A spout extends from the base for dispensing the total amount of liquid.

Another object of the invention is to provide a liquid-dispensing apparatus comprising a measuring flow-restrictor apparatus with shut-off capability connected to a control device capable of varying the flow of first pressurize source liquid through the first circuit based on the desired volume to be dispensed. A first circuit is constructed and adapted for connection to a first pressurized source of liquid. The first circuit includes a measuring flow-restrictor apparatus with shut-off capability which is capable of measuring the volume of liquid that flows through the circuit using a measurement apparatus that is in fluidic contact with the first circuit. The measuring flow-restrictor apparatus with shut-off capability varies the flow rate of the liquid flowing through the circuit by varying an externally applied load resistance placed on the measurement apparatus. The measuring flow-restrictor apparatus with shut-off capability may increase the flow rate of the liquid flowing through the first circuit by varying an externally applied pumping action applied to the measurement apparatus. The measuring flow-restrictor apparatus with shut-off capability may terminate the flow of liquid flowing through the circuit by restricting the movement of the measurement apparatus.

Another object of the invention is to provide a means within the control device to measure the volume of first pressurized source liquid dispensed while also providing a means of increasing or decreasing the flow rate by reducing or increasing the flow resistance on the first pressurized source liquid by varying a load resistance applied to the measurement apparatus.

Another object of the invention is to provide a device that is readily available in the kitchen near the sink, cooking, or food preparation areas that would dispense an operator-selected volume of liquid with the accuracy required by recipes or pre-packaged foods. The device rapidly dispenses the desired volume of liquid into a container, and is programmed to limit the liquid flow rate based on the volume of liquid desired to prevent splashing or loss of the ensuing mixture. The device also dispenses a wide range of volumes ranging from a fractional teaspoon to gallons of liquid with sufficient accuracy and consistency required by cooking recipes and food preparation.

Another object of this invention for this new device is to dispense a measured volume of extremely hot water for preparing instant or hot beverages, and for reconstituting pre-packaged foods. The measured volumes are programmed and stored in the memory contained within the device and may be adjusted by the operator. These predefined measured volumes are typical for such foods and beverages and provide the operator a margin of safety by reducing the risk of scalding or overflowing the container as the hot liquid is dispensed.

It is a further object of this invention for this new device to provide for changing the temperature of the liquid to be dispensed across a range of temperatures. The dispensed liquid temperature may be adjusted on demand by the consumer throughout the temperature range of below room temperature but above freezing to a temperature near boiling. The device may include preset temperatures for dispensing liquids at temperature commonly needed within the kitchen for recipes and food preparation.

It is a further object of the invention to provide a method of dispensing a desired volume wherein the operator dispenses several arbitrary volumes of liquid, followed by a final dispensing of liquid to the desired preset volume.

It is a further object of the invention to provide a method of rapidly dispensing the desired volume of liquid while controlling the flow of liquid through the faucet into a container filled with ingredients, thereby preventing the liquid splashing out or a loss of mixture from the container while the liquid is being added.

In one of its aspects, the present invention may be retrofitted to a kitchen faucet assembly for measuring and dispensing a desired volume of water by controlling the hot and cold water supply sources to the existing faucet or sprayer.

Another aspect of this device is a control device attached to a kitchen sink garbage disposal. The control device provides a signal for activating the garbage disposal only when the liquid flow sensor detects a sufficient volume of water flowing through the faucet. The garbage disposal would turn off when the flow of water through the faucet is interrupted; thereby preventing damage to the garbage disposal.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is an electrical and plumbing diagram of an All-in-One dispensing faucet with auxiliary water heater and garbage disposal controller using the valve method.

FIG. 2 is a block diagram of an All-in-One kitchen dispensing faucet.

FIG. 3 is an illustration of an All-in-One electronic kitchen dispensing faucet with control panel and including a manual liquid temperature and volume control handle.

FIG. 4 is an illustration of an All-in-One electronic kitchen dispensing faucet with control panel and including a manual liquid temperature and volume control handle.

FIGS. 5A and 5B are block diagram of the control sequence used to control an All-in-One kitchen dispensing faucet using the valve method.

FIG. 6 is an electrical and plumbing diagram of a typical kitchen sink retrofitted with an Auxiliary design dispensing faucet using the valve method.

FIG. 7 is a block diagram of a typical kitchen sink modified with an Auxiliary design dispensing faucet.

FIG. 8 is an electrical and plumbing diagram of a typical kitchen faucet retrofitted with an Add-on dispensing faucet using the valve method.

FIG. 9 is a block diagram of a typical kitchen sink faucet retrofitted with an Add-on dispensing apparatus and control module.

FIGS. 10A, and 10B is a block diagram of the control sequence used to control a typical kitchen sink retrofitted with an Add-on dispensing apparatus and control module.

FIG. 11 is a table of flow rate settings used while dispensing an operator-desired volume of liquid.

FIGS. 12, 13A, 13B, 14, 15, 16A, and 16B are diagrams of a second embodiment incorporating a positive-displacement pump, the diagrams being similar to FIGS. 1, 5A, 5B, 6, 8, 10A, and 10B, respectively and being usable in the apparatus shown in FIGS. 2-4, 7, 9, and 11.

FIGS. 17, 18A, 18B, 19, 20, 21A, and 21B are diagrams of a third embodiment incorporating a measuring flow-restrictor apparatus with shutoff, the diagrams being similar to FIGS. 1, 5A, 5B, 6, 8, 10A, and 10B, respectively and being usable in the apparatus shown in FIGS. 2-4, 7, 9, and 11.

FIG. 22 is a diagram of a fourth embodiment, the diagram being similar to but simplified from that of FIG. 17.

### DETAILED DESCRIPTION

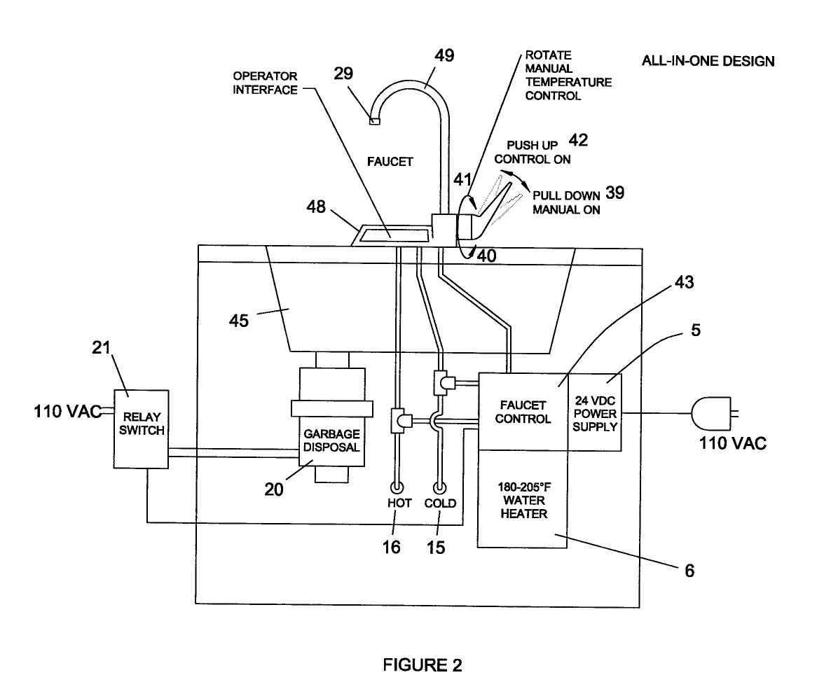

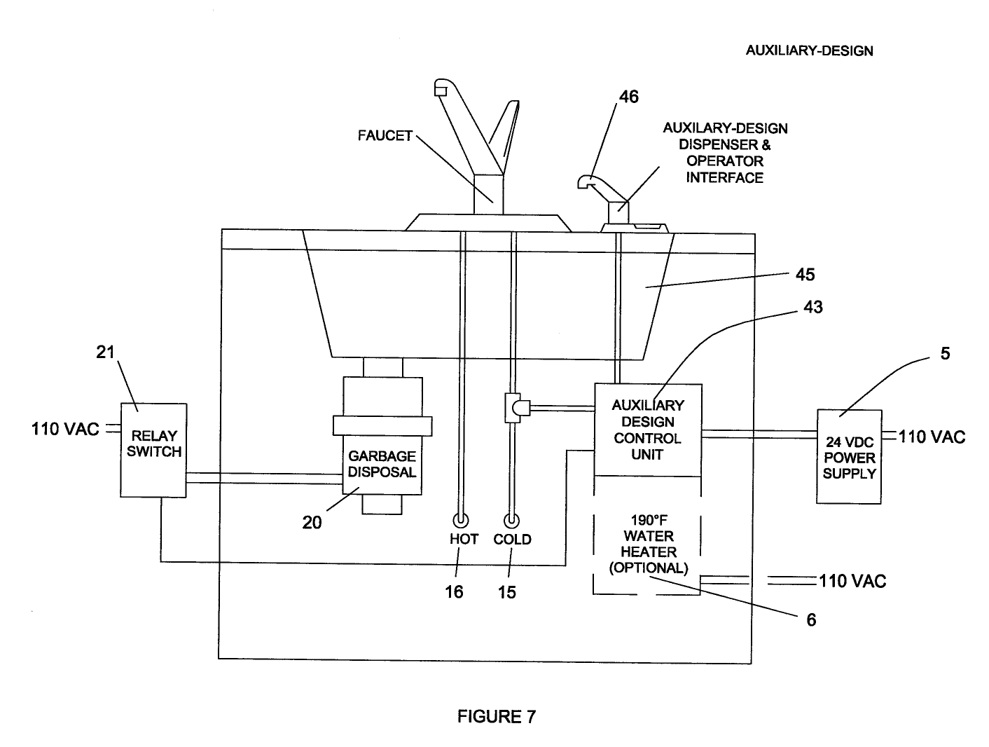

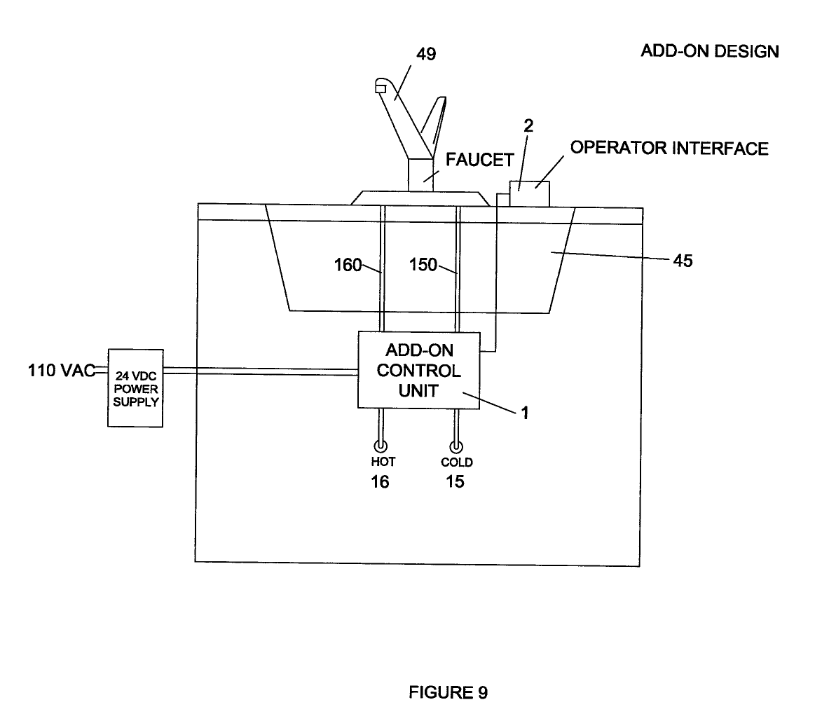

This invention is described using three (3) different faucet designs: All-in-One design, Auxiliary design, and Add-on design. The All-in-One design replaces the standard faucet as shown in FIGS. 2, 3, and 4. The Auxiliary design is installed adjacent to a standard faucet as shown in FIG. 7. The Add-on design is added to a standard faucet as shown in FIG. 9. Each of these designs could use any one of the control methods described below.

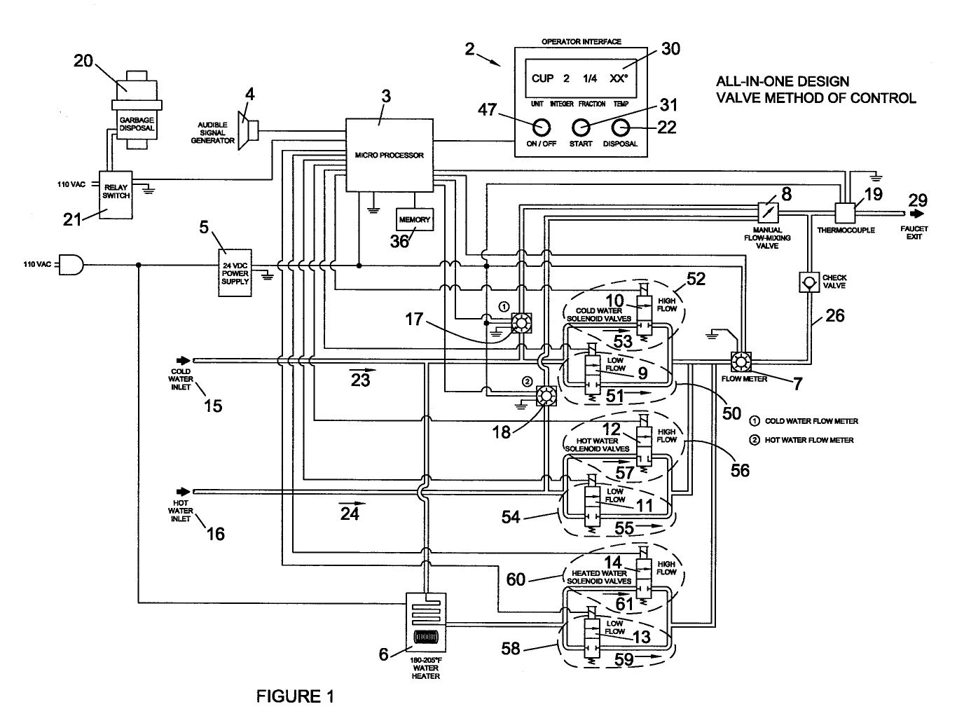

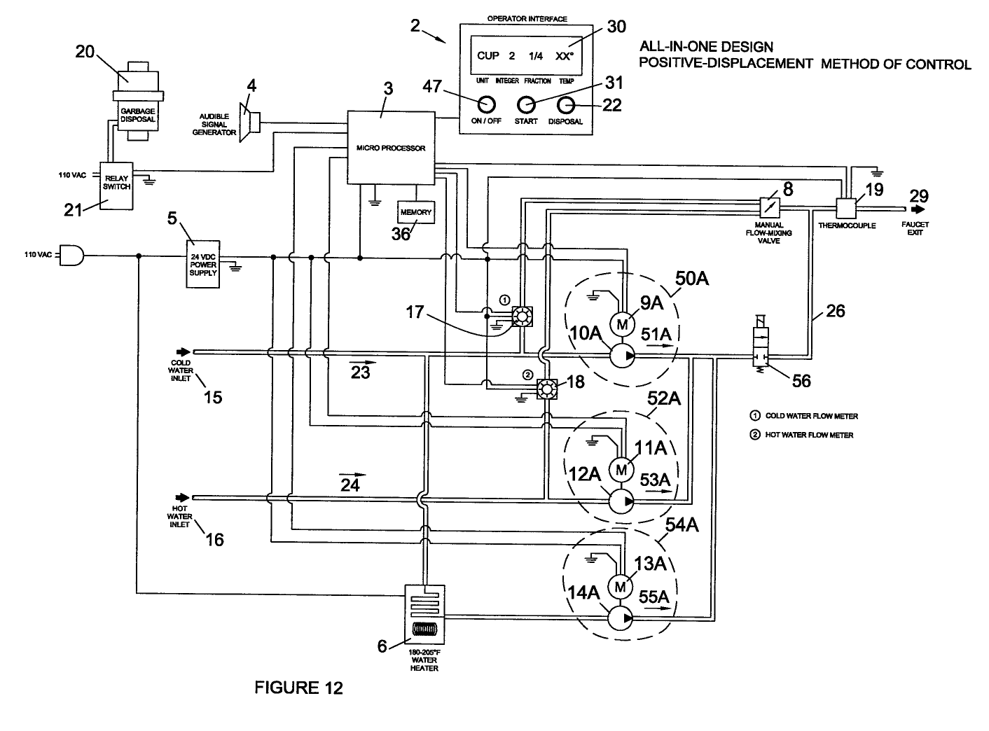

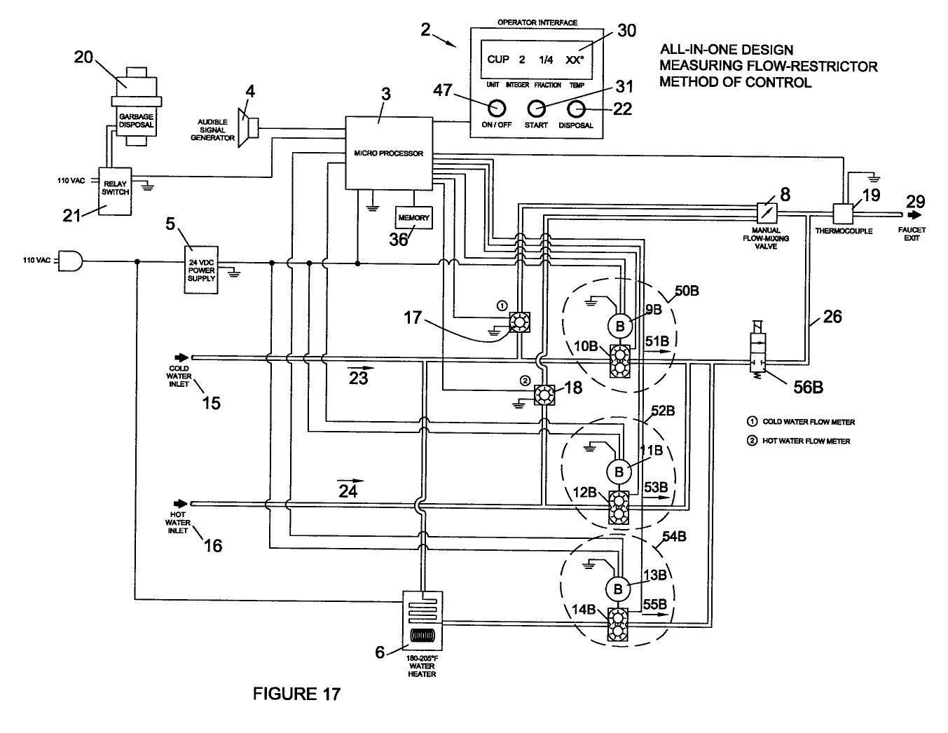

This invention is controlled by one of three (3) methods: valves, positive-displacement pump, and measuring flow-restrictor. The valve method is shown in FIGS. 1, 6 and 8. The positive-displacement pump method is shown in FIGS. 12, 14, and 15. The measuring flow-restrictor is shown in FIGS. 17, 19, 20 and 22. Each of these methods could be used on any one of the designs described above.

The apparatus 1 (FIGS. 1 and 2) for an electronic dispensing kitchen faucet includes a base 48, a spout 49, a first circuit 50, a first flow meter 7, and a programmable controller 3. The base 48 is adapted for mounting to a kitchen sink 45. The spout 49 extends from the base 48 for dispensing the total amount of liquid. The first circuit being adapted for connection to a first source of liquid 15 to dispense liquid from the first source at a first flow rate 51. The first circuit 50 includes a first valve 9 for controlling the flow of the liquid from the first source through the first circuit 50.

The first flow meter 7 measures the volume of liquid dispensed through the first circuit 50. The first flow meter 7 is shown in FIG. 1 in the circuit after the first circuit 50. However, it should be understood by those skilled in the art that the first flow meter 7 may be positioned before the first circuit 50 or it may be positioned within the first source liquid circuit. In either of these positions, the first flow meter 7 will accurately measure the amount of first source liquid flowing through the faucet exit 29.

The programmable controller 3 is operably connected to the first flow meter 7 and to the first valve 9. The controller 3 is programmed and adapted to receive first signals from the first flow meter 7. The controller 3 generates control signals to actuate and de-actuate the first valve 9 to dispense an accurate total amount of liquid from the spout 49.

The apparatus 1 for an electronic dispensing kitchen faucet includes a first circuit 50, a second circuit 52, a first flow meter 7, and a programmable controller 3 as shown in FIG. 1. The first circuit being adapted for connection to a first source of liquid 15 to dispense liquid from the first source at a first flow rate 51. The first circuit 50 includes a first valve 9 for controlling the flow of the liquid from the first source through the first circuit 50.

The second circuit 52 is adapted for connection to a first source of liquid 15 to dispense liquid from the first source at a second flow rate 53. The second circuit 52 includes a second valve 10 for controlling the flow of the liquid from the first source through the second circuit 52.

The first flow meter 7 measures the volume of liquid dispensed through the first and second circuits 50, 52. The first flow meter 7 is shown in FIG. 1 in the circuit after the first and second circuits 50 and 52 are joined together. However, it should be understood by those skilled in the art that the first flow meter 7 may be positioned before the first and second circuits 50, 52 or it may be positioned within the first source liquid circuit. In either of these positions, the first flow meter 7 will accurately measure the amount of first source liquid flowing through the faucet exit 29.

The programmable controller 3 is operably connected to the first flow meter 7 and to the first and second valves 9 and 10, respectively. The controller 3 is programmed and adapted to receive first signals from the first flow meter 7. The controller 3 generates control signals to actuate and de-actuate the first and second valves 9, 10 to dispense an accurate total amount of liquid.

Another embodiment of the apparatus 1 for an electronic dispensing kitchen faucet includes a first circuit 50, a second circuit 52, a common outlet circuit 26, and a programmable controller 3. The first circuit 50 is adapted for connection to a first source of liquid 15 to dispense liquid from the first source at a first flow rate 51. The first circuit 50 includes a first valve 9 for controlling the flow of the liquid from the first source through the first circuit 50.

The second circuit 52 is adapted for connection to a first source of liquid 15 to dispense liquid from the first source at a second flow rate 53. The second circuit 52 includes a second valve 10 for controlling the flow of the liquid from the first source through the second circuit 52.

The first and second circuits 50, 52 are connected together to form a common outlet circuit 26. The first flow meter 7 measures the volume of liquid dispensed through the common outlet circuit 26.

The programmable controller 3 is operably connected to the first flow meter 7 and to the first and second electric solenoid valves 9 and 10, respectively. The controller 3 is programmed and adapted to receive first signals from the first flow meter 7. The controller 3 generates control signals to actuate and de-actuate the first and second valves 9, 10 to dispense an accurate total amount of liquid.

Another embodiment of the apparatus 1 for an electronic dispensing kitchen faucet includes a first flow meter 7, a first and second electric solenoid valves 9 and 10 respectively, an operator input device 2, a start input switch 31, and a programmable controller 3.

The first flow meter 7 connects to a first source of liquid 15 and produces a first flow signal indicating the volume of liquid flowing through the flow meter and a faucet exit 29. The first electric solenoid valve 9 is connected to a first source of liquid 15 and to the first flow meter 7 and controls the liquid flow rate at a first flow rate 51. The second electric solenoid valve 10 is connected to the first source of liquid 15 and to the first flow meter 7 and controls the liquid flow rate at a second flow rate 53. The second flow rate 53 is typically 3-5 times greater than the first flow rate 51.

The operator input device 2 allows the operator to specify the volume of liquid desired, as well as other parameters, settings, and values useful for liquid dispensing. The operator input contains a display 30 for communicating information to the operator such as volume dispensed, volume to be dispensed, temperature of the liquid being dispensed, and other parameters or settings. The parameters and settings are stored in memory 36 and used by the programmable controller 3 while operating the faucet apparatus 1.

The start input switch is used to initiate liquid dispensing through the electronic kitchen dispensing faucet apparatus. When the start input switch 31 is depressed, the apparatus initiates dispensing. If the start input switch 31 is depressed while the apparatus is dispensing, the apparatus will pause the liquid dispensing pending further action by the operator. The liquid dispensing will complete the dispensing operation if the start input switch 31 is depressed while the apparatus 1 is paused.

The programmable controller 3 receives input from the operator input 2 and start input switch 31 and contains an audible signal generator 4 for alerting the operator of errors or when the liquid dispensing cycle is complete. The programmable controller 3 communicates with the operator by displaying information on the display 30. The programmable controller 3 generates control signals to initiate liquid flowing from the first source of liquid 15. These control signals actuate the first and second electric solenoid valves to achieve the desired flow rate through the faucet apparatus 1.

The programmable controller 3 receives input signals from the first flow meter 7 representing the volume of liquid flowing. The controller 3 sums the first flow signals and compares the total volume dispensed to the desired operator volume input. The controller 3 generates control signals to the first and second electric solenoid valves 9, 10 to stop the flow of liquid when the desired volume of liquid has been dispensed from the faucet apparatus 1 into the container 44.

An example of such a flow meter is produced by Omega Engineering and sold as the FTB2000 Series Economical Flowrate Sensor. The Omega Engineering flow rate sensor is available in several flow rate resolutions and flow capacities. It should be noted that other flow meter designs may be equally substituted for measuring the volume of liquid flowing through the faucet outlet. These flow meters may generate pulsed signals or frequency output signals representative of the finite volume of liquid flowing through them.

The first electric solenoid valve 9 controls the flow of the first source liquid 15 at a first flow rate 51. The second electric solenoid valve 10 controls the flow of the first source liquid 15 at a second flow rate 53. The cumulative volume of first source liquid 15 flowing through the first and second electric solenoid valves 9, 10 flows through the first flow meter 7 and is dispensed from the faucet exit 29.

The first flow meter 7 generates first flow signals representative of the volume of liquid flowing through the first flow meter 7. The first flow signals are connected to the programmable controller 3 for processing. The programmable controller 3 sums the first flow signals and stores the resulting total volume of first source liquid dispensed from the faucet exit 29 in memory 36 for later use.

The operator input 2 provides a means for the operator to specify the volume of first source liquid 15 to be dispensed from the faucet apparatus 1. The operator may select from volumetric units typical of recipes or volumes of liquid used in the kitchen which would be displayed to the operator on a display 30. These volumetric units may be either English or metric. English volumetric units include teaspoon (tsp), tablespoon (Tbsp), ounces (oz), cups (c), pints (pt), quarts (qt), or gallons (gal). Metric volumetric units include milliliters (ml) or liters (l). Once the operator selects the volumetric units for input, the quantity is specified by the operator using the operator input 2. The operator may specify the quantity of the specified volumetric unit in either decimal or fractional increments. As an example, English units are typically required in fractional increments of the selected volumetric unit. (e.g., ⅔ teaspoon, ¼ cup, ½ gallon, etc.) The present apparatus 1 will automatically accurately and repeatedly dispense selected volumes of liquid input into the input device 2, including amounts as small as ½ teaspoon, and do so to at least about 10% accuracy, and more preferably to within about 5% accuracy, and even to within about 2% accuracy, depending on the system components selected for use.

The operator input 2 includes an audible signal generator 4. Numerous audible signal generators are known within the industry. These include audio speakers of various designs and manufacturing styles; some are designed for direct exposure to high moisture environments which may include direct contact with liquids. Other audible signal generators include fixed frequency generators that may be controlled in duration or intensity. The programmable controller 3 audible output signal connects to the audible signal generator 4 for frequency, intensity, and duration control. The programmable controller 3 outputs the appropriate signal to alert the operator of various conditions while dispensing liquid. These operator alerts may include feedback that operator input 2 has been acknowledged, errors have occurred while dispensing liquid, or to alert the operator prior to dispensing elevated or hot temperature liquids from the faucet to prevent scalding the operator.

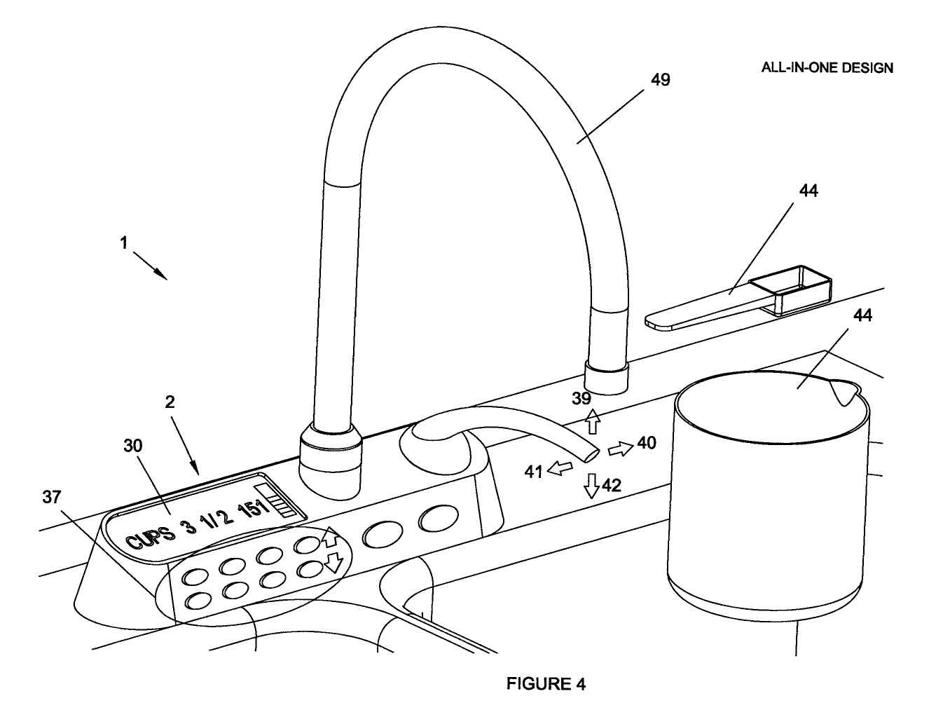

An alternative operator input device 2 can include individual increment and decrement input buttons for each volumetric unit and parameter to be dispensed as shown in FIG. 4, item 37. The operator would press the increment or decrement switch input means to select between the available fractional or decimal volume for each unit.

Another operator input device would include a traditional keypad that includes the numeric digits 0-9 and additional keys for each volumetric unit. The operator would input the desired numeric or fractional value before or after specifying the units.

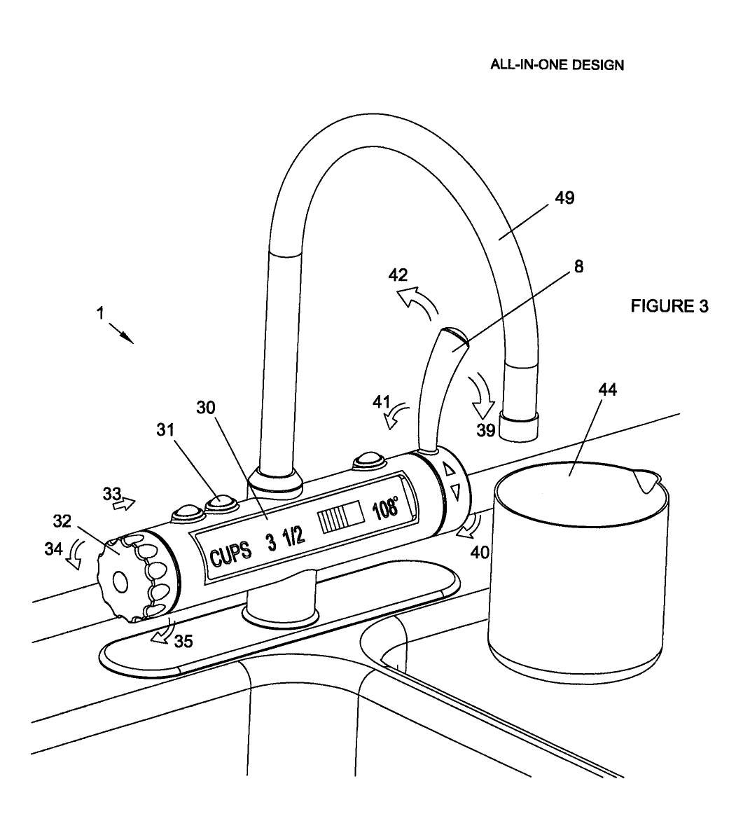

More specifically, the electronic kitchen dispensing faucet 1 as shown in FIG. 3 includes a rotary switch 32 that is rotated by the operator in the forward direction 34 or reverse direction 35. Using the rotary switch 32, the operator increments or decrements the decimal or fractional unit volume of liquid to be dispensed from the faucet apparatus 1. As the rotary switch 32 is moved in the forward direction 34, the value selected is incremented. Likewise, as the rotary switch 32 is moved in the reverse direction 35, the value selected is decremented. It is well understood in the industry that the forward and reverse directions 34, 35 are interchangeable in incrementing and decrementing the value selected and is primarily an operator preference. The rotary switch 32 also contains a perpendicular input switch 33 that is actuated when the operator presses the rotary switch 32 in the direction perpendicular to its rotation.

The perpendicular input switch 33 selects the volumetric unit or other parameter to be input by the operator. Each press of the perpendicular input switch 33 selects the next volumetric unit or parameter to be adjusted by the operator. As an example when operating in the English volumetric mode, the operator may select between the English units of tsp, Tbsp, oz, pt, qt, and gal. The perpendicular input switch 33 may select between other non-numeric input parameters such as temperature, garbage disposal, and country.

When non-numeric input parameters are selected by the perpendicular input switch 33, the rotary switch 32 would be used to select between the possible values. The possible values may be numeric or specific non-numeric settings. As an example, when the COUNTRY parameter is selected, the rotary switch would allow the operator to select between ENGLISH or METRIC values by rotating the rotary switch 32 in either the forward or reverse direction 34, 35.

A start input switch 31 creates a start signal to the programmable controller 3 indicating the operator's desire to operate the electric kitchen dispensing faucet apparatus 1. The start input switch 31 may be any style switch known within the industry. This switch could be of a mechanical actuator, capacitive sensing, magnetic sensing, or optical switch input means that generates a signal to the programmable controller indicating the operator's intent to operate the faucet apparatus 1.

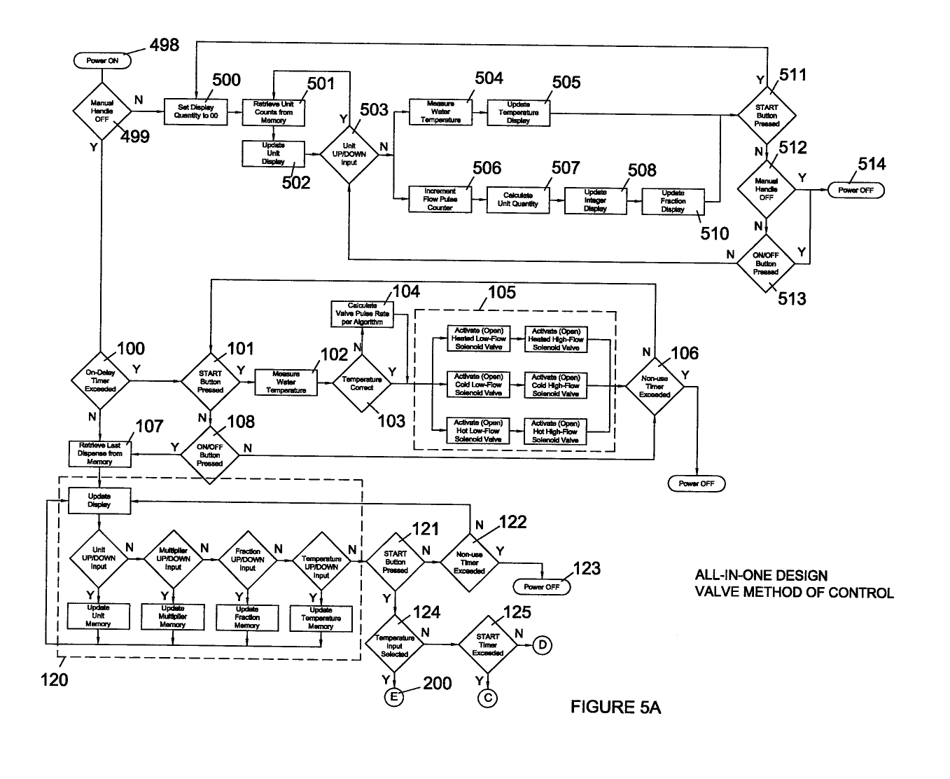

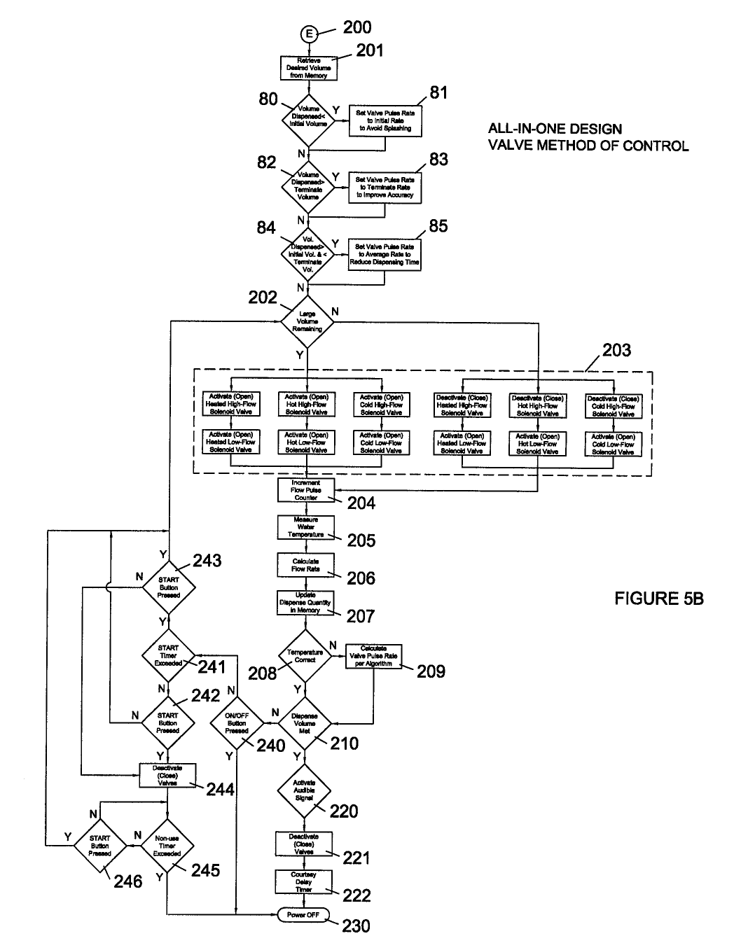

The programmable controller 3 receives input signals from the first flow meter 7, operator input 2, and start input switch 31. The programmable controller 3 produces control signals to the first and second electric solenoid valves 9 and 10, respectively, and display 30. The programmable controller 3 monitors the start input switch signal to initiate, pause, or stop the flow of liquid through the faucet as shown in FIGS. 5A and 5B. The programmable controller 3 generates a first and second control signal in sequence which actuates the first and second electric solenoid valves 9 and 10, respectively, as needed to control the flow rate of the first source liquid flowing through the first flow meter 7 and dispensed from the faucet exit 29.

Continuing to refer to FIG. 1, the electronic kitchen dispensing faucet apparatus 1 may also include a third circuit 54, a fourth circuit 56, and a temperature sensor 19. The third circuit 54 is adapted for connection to a second source of liquid 16 to dispense liquid from the second source at a third flow rate 55. The third circuit 54 includes a valve 11 for controlling the flow of liquid from the second source through the third circuit 54. The fourth circuit 56 is adapted for connection to a second source of liquid 16 to dispense liquid from the second source at a fourth flow rate 57. The fourth circuit 56 includes a valve 12 for controlling the flow of liquid from the second source through the fourth circuit 56. The fourth flow rate 57 is typically 3-5 times greater than the third flow rate 55.

The second source of liquid 16 is typically available in residential or commercial kitchens providing an elevated temperature water source. This elevated temperature water source is typically at a temperature between 130 and 190 degrees Fahrenheit.

The first, second, third, and fourth circuits 50, 52, 54, 56 are connected together to form a common outlet circuit. The first flow meter 7 generates signals representing the volume of liquid flowing through the flow meter 7 and common outlet circuit 26 and dispensed from the faucet exit 29.

The temperature sensor 19 may be selected from several temperature sensors known within the industry. The temperature sensor may be any of a variety of thermocouple sensor styles (J, K, T, E, R, S) which use different bimetal junctions to create an electrical voltage which increases or decreases proportionally as the temperature increases or decreases. Other temperature sensors use various materials to create a change in resistance as the temperature changes. The temperature sensor is positioned within the liquid conduit between the first flow meter outlet and the faucet exit 29. The temperature sensor measures the resulting temperature of the liquids flowing through the faucet exit 29.

The temperature sensor 19 is capable of sensing liquid temperatures between 32 and 212 degrees Fahrenheit. The temperature sensor 19 measures the resulting temperature of the first and second source liquids 15, 16 and the reservoir liquid flowing through the faucet apparatus 1.

The operator input 2 allows the operator to define the resultant liquid temperature dispensed from the faucet exit 29. The operator input 2 allows the operator to select a temperature to be dispensed from commonly used temperatures, or the operator may enter the temperature directly into the operator input 2. The present apparatus 1 will automatically accurately and repeatedly dispense liquids at selected temperatures from as low as the normal cold water source of a household (e.g. about 60 degrees) to as high as the normal hot water source of a household (e.g. about 200 degrees), and will do so within at least about 5 degrees Fahrenheit of the selected temperature input into input device 2, or more preferably within about 2 degrees Fahrenheit of the selected temperature, or even to within about 1 degree Fahrenheit of the selected temperature.

The programmable controller 3 generates control signals that actuate the first, second, third, and fourth electric solenoid valves 9, 10, 11, 12, resulting in liquid flowing through the corresponding valve and circuit. The programmable controller 3 receives an electric voltage signal from the temperature sensor 19 representative of the liquid temperature dispensed from the faucet exit 29. The programmable controller 3 converts the temperature sensor electrical voltage into a dispensed liquid temperature. The programmable controller 3 then compares the dispensed liquid temperature to the desired operator temperature. The programmable controller calculates the pulse rate for the first, second, third, and fourth electric solenoid valves 9, 10, 11, 12 to adjust the temperature and volume of liquid flowing from the faucet exit 29. The programmable controller 3 determines the magnitude of temperature error in the resultant liquid dispensed from the faucet and increases the flow rate in the temperature direction of adjustment required. The solenoid pair attached to the opposing temperature liquid source may be reduced if the flow rate exceeds the maximum flow rate for the volume being dispensed or if a greater temperature error exists.

Continuing to refer to FIG. 1, the electronic kitchen dispensing faucet apparatus 1 may also include a fifth circuit 58, a sixth circuit 60, and a heated liquid reservoir 6. The heated liquid reservoir 6 has an inlet and outlet, the inlet connected to the first source liquid 15, the heated liquid reservoir 6 maintaining the temperature of the liquid in the reservoir at a temperature between 180 and 205 degrees Fahrenheit. The reservoir 6 heats the first source liquid 15 flowing into the reservoir. The reservoir 6 contains a heating element and temperature regulating means to maintain the liquid within the reservoir at an elevated temperature between 180 and 205 degrees Fahrenheit. The liquid stored within the reservoir becomes a third source liquid for dispensing from the electronic kitchen dispensing faucet.

The fifth circuit 58 is adapted for connection to the outlet of the heated liquid reservoir 6 to dispense hot liquid from the heated reservoir 6 at a fifth flow rate 59. The fifth circuit 58 includes a valve 13 for controlling the flow of hot liquid from the heated liquid reservoir 6 through the fifth circuit 58. The sixth circuit 60 is adapted for connection to the outlet of the heated liquid reservoir 6 to dispense hot liquid from the heated liquid reservoir 6 at a sixth flow rate 61. The sixth circuit 60 includes a valve 14 for controlling the flow of hot liquid from the heated liquid reservoir 6 through the sixth circuit 60. The sixth flow rate 61 is typically 3-5 times greater than the fifth flow rate 59.

The first, second, third, fourth, fifth, and sixth circuits 50, 52, 54, 56, 58, 60 are connected together to form a common outlet circuit 26. The first flow meter 7 generating signals representing the volume of liquid flowing through the first flow meter 7 and common outlet circuit 26 and dispensed from the faucet exit 29.

The programmable controller 3 generates control signals connected to the first, second, third, fourth, fifth, and sixth electric solenoid valves 9-14 for actuating the corresponding valve resulting in liquid flowing through the valve and dispensed from the faucet exit 29. The programmable controller 3 receives an electric voltage signal from the temperature sensor 19 proportional to the liquid temperature dispensed from the faucet. The programmable controller 3 converts the temperature sensor electrical voltage into a dispensed liquid temperature. The programmable controller 3 then compares the dispensed liquid temperature to the operator desired liquid temperature. The programmable controller 3 calculates the pulse rate needed for actuating the first, second, third, fourth, fifth, and sixth electric solenoid valves 9-14 to adjust the temperature and volume of liquid flowing through the faucet exit 29. The programmable controller 3 determines the magnitude of temperature error in the resultant liquid dispensed from the faucet and increases the flow rate in the temperature direction of adjustment required. The solenoid pair attached to the opposing temperature liquid source may be reduced if the flow rate exceeds the maximum flow rate for the volume being dispensed.

The programmable controller 3 determines the initial flow rate 71 by comparing the operator input volume 75 to a table of volumes 70 with corresponding output flow rate parameters stored in memory 36. The programmable controller 3 selects the appropriate initial flow rate 71. The initial flow rate 71 limits the flow rate of liquid dispensed from the faucet exit 29 to insure the liquid does not splash or gush out of the container 44 used to capture the dispensed liquid. The output flow rate is also determined and limited by the total volume of liquid to be dispensed, and the actual volume of liquid dispensed from the faucet exit 29 into the container 44.

The flow rate through the electric solenoid valves is reduced to a termination flow rate 73 when the actual volume dispensed is near the total volume desired by the operator to insure volumetric accuracy. The programmable controller 3 determines the termination flow rate 73 by comparing the operator input volume 75 to a table of volumes 70 with corresponding output flow rates stored in memory 36. The programmable controller 3 selects the appropriate terminating flow rate 73. The flow rate through the faucet exit 29 may be abruptly terminated as the total volume dispensed increases above a predefined volume. By abruptly terminating the flow of liquid, liquid volumes above this predefined volume are rapidly dispensed without compromising volumetric accuracy dispensed into the container.

The flow rate through the electric solenoid valve is maintained at an average flow rate 72 while dispensing the source liquids when the volume dispensed is greater than the initial volume but less than the operator input volume less the termination volume. The programmable controller 3 determines the average flow rate 72 by comparing the operator input volume to a table of volumes 70 with corresponding output flow rates stored in memory 36. The programmable controller 3 selects the appropriate average flow rate 72.

The flow rate through the faucet exit 29 is limited to a maximum flow rate 74 whenever dispensing a measured volume of liquid. This maximum flow rate 74 is determined by the maximum first flow meter characteristics. By limiting the flow rate through the faucet exit 29 to the maximum flow rate 74, the volumetric accuracy is insured.

Once the operator-specified volume has been dispensed through the kitchen faucet or the dispensing operation suspended by the operator, the programmable controller 3 remains idle waiting for additional operator input. If no operator input is received within a selected time interval, the electronic kitchen dispensing faucet apparatus 1 will turn power off to the unit to conserve electricity and to turn off the operator display illumination source which could be annoying to the operator during the nighttime.

Now referring to FIG. 5A, the operator initially turns the electronic kitchen dispensing faucet apparatus 1 to the ON position which initializes an On-Delay timer value to zero and starts a timing sequence within the programmable controller 3. The current value of the On-Delay timer is then compared to a preset value as shown in step 100 to see if the On-Delay timer has exceed the preset value. If so, the start input switch 31 signal is tested in step 101 and if activated, the liquid temperature is measured 102 and compared to an operator desired temperature 103. If the current temperature measured in step 102 is not at the desired value, the electric solenoid pulse rate is adjusted 104 prior to the electric solenoids being actuated and de-actuated 105 based on a pulse rate calculated to maintain the average flow rate 72 and to regulate the liquid temperature flowing from the faucet exit 29 at the operator desired temperature. As long as the operator continues to hold the start input switch 31 depressed maintaining the start input signal activated 101, the flow of liquid through the faucet exit 29 continues. This cycle allows the operator to prime or preheat the faucet components with elevated temperature liquid to insure the desired liquid temperature is dispensed in a subsequent dispensing cycle.

The operator activates the On/Off switch signal 108 to retrieve the previous dispensed volume stored in memory 107. The operator input 2 then displays the current value and allows the operator to adjust the units and values to the desired volume and temperature for dispensing 120. When the desired volume has been selected by the operator, the start input switch 31 is depressed by the operator which generates a start input switch signal activation 121 which starts a timing sequence by initializing a start timer value to zero. The start timer value measures the duration the start input switch 31 is activated. The start timer value is compared to a preset value. If the start timer exceeds the preset value, the electric solenoid valves will be actuated while the start input switch 31 remains depressed, activating the start input signal as shown in FIG. 5B, which will dispense liquid while the start input switch 31 is activated 243 or until the dispensed volume equals the dispensed volume 210.

If the start input switch 31 is de-activated before the start timer exceeds the preset value 241, the dispensing process continues as shown in FIG. 5B step 242, which dispenses liquid until the operator desired volume has been dispensed 210; or the start input switch 31 is activated 242. If the start input switch 31 signal is activated while liquid is flowing 242, the electric solenoid valves are de-actuated which suspends liquid flowing through the faucet exit 29. When the operator depresses the start input switch 31 signal as shown in step 246, the liquid dispensing continues until the dispensed volume is dispensed 210 or the operator activates the On/Off input switch signal 240.

Now referring to FIG. 5B, the operator input stored volume of liquid to be dispensed is retrieved 201 from memory 36. The programmable controller 3 compares the volume to be dispensed to a predefined volume 202 to adjust the liquid flow rate based on the operator desired volume of liquid. If the dispensed volume is above the predefined volume, the electric control valves are actuated at a pulse rate to dispense at a high flow rate. If the dispensed volume is below the predefined volume, the electric control valves are actuated at a pulse rate to dispense at a lower flow rate as shown in step 203.

The first flow meter signals are added to the accumulated pulses and calculations performed to determine the total volume of liquid dispensed in step 204. The accumulated total volume dispensed is stored in memory as shown in step 207. The temperature sensor 19 is read by the programmable controller 3 in step 205. The average flow rate through the faucet exit 29 is calculated by dividing the total volume of liquid dispensed by the time elapsed while dispensing as shown in step 206.

The current dispensed liquid temperature is compared to the desired operator input temperature in step 208. Each electric solenoid valve pulse rate is adjusted based on the difference between the current temperature and desired temperature. The flow rate through each electric solenoid is factored into the new pulse rates stored in memory.

The actual dispensed volume is then compared to the desired operator requested volume in step 210; if the electronic kitchen dispensing faucet apparatus 1 has dispensed the desired volume of liquid, an audible alarm is signaled 220 and the electric solenoid valves are de-actuated 221. A courtesy delay is provided in step 222 for the operator to review the liquid dispensing information shown on the display 30 before the electronic kitchen dispensing faucet apparatus is turned off to conserve electricity.

If all liquid has not been dispensed, the On/Off switch signal is tested by the programmable controller 3 to determine if the operator has decided to turn the kitchen dispensing faucet Off 240. The programmable controller 3 then tests to determine if the start timer has exceeded a preset value to determine if the operator is holding the start input switch depressed 241. If so, the faucet apparatus 1 dispenses the volume of liquid while the operator continues to press and hold the start input switch 31 depressed 243 and will stop dispensing when the start input switch 31 is released.

If the start input switch 31 signal is momentarily pressed, the liquid is dispensed without further intervention by the operator as shown in step 242. If while dispensing the liquid the operator presses the start input switch 31 signal, the programmable controller 3 will stop the flow of liquid through the faucet exit 29 and store the present volume dispensed as shown in step 244. If the operator fails to complete the dispensing before the non-use timer is exceeded 245, power to the electronic kitchen dispensing faucet apparatus 1 is turned off 230. The operator can continue dispensing liquid by pressing the start input switch 31 signal as shown in step 246.

The programmable controller 3 may determine the maximum volume of heated liquid that may be dispensed from the liquid reservoir 6 during a single dispensing. The operator input volume is compared to this maximum heated liquid volume prior to dispensing. If the operator input volume is greater that the maximum heated liquid volume, the programmable controller 3 will alert the operator by controlling the signal connected to the audible signal generator 4.

A table of frequently dispensed heated liquid volumes may be maintained in the memory 36. This table would include the predefined liquid volume and temperature. The operator input 2 will allow the operator to select a predefined volume and temperature of heated liquid for measured dispensing from the electronic kitchen dispensing faucet apparatus 1. These frequently dispensed volumes and temperatures are typical of pre-packaged food products like instant soups, tea, coffee, cocoa, or other hot beverages. The table of volumes and temperatures may be preprogrammed from the manufacturer or input by the operator and stored in memory 36 for future use.

To use the table of frequently dispensed heated liquid volumes and temperatures, the operator input would enable the selection from the table of heated volumes and temperatures. The operator would then scroll through each entry stored in memory 36. When the desired table entry is located by the operator, the operator would then select this entry for subsequent dispensing when the start input switch 31 is activated.

Now referring to FIG. 1, the electronic kitchen dispensing faucet apparatus 1 may also include a manual mixing valve 8, a second and third flow meter 17 and 18 respectively for measuring the volume of the first and second source of liquids flowing through the faucet exit 29 as a result of the manual mixing valve actuation. The manual mixing valve 8 provides the means for the operator to infinitely adjust the flow rates of the first and second source liquids 15, 16 through the manual mixing valve 8 and to be dispensed from the faucet exit 29.

The second flow meter 17 inlet is in fluid connection with the first source of liquid 15 and the outlet being in fluid connection with the first inlet of the manual mixing valve 8. The third flow meter 18 inlet is in fluid connection with the second source of liquid 16 and the outlet is in fluid connection with the second inlet of the manual mixing valve 8. The manual mixing valve 8 outlet is in fluid connection with the liquid conduit connected to the first flow meter 7 outlet, temperature sensor 19, and faucet exit 29.

The second and third flow meters 17, 18 generate signals representative of the volume of liquid flowing through their respective flow meter, these signals are connected to the programmable controller 3 which sums the discrete volumes represented by each signal pulse and accumulating the total volume flowing of the first and second source liquid 15, 16 in its memory 36 for future processing.

The programmable controller 3 may display the accumulated volume of liquid flowing through the second and third flow meters 17, 18, and the average temperature dispensed from the faucet into a container on the display of the operator input 2 while the manual mixing valve 8 is actuated by the operator.

The operator can close the manual mixing valve 8, and using the operator input 2 select a total volume and temperature for dispensing by the electronic kitchen dispensing faucet apparatus 1. The programmable controller 3 will calculate the remaining volume of liquid by subtracting the volume of liquid dispensed through the manual mixing valve from the desired volume selected from the operator input 2. The programmable controller 3 will then actuates the electric solenoid valves in sequence to dispense the remaining volume of liquid from the faucet exit 29.

The programmable controller 3 may also sequence the electric solenoid valves to complete the dispensing of liquid at the average temperature set by the operator using the manual mixing valve position. The programmable controller 3 may also sequence the electric solenoid valves to complete the dispensing of liquid at the same flow rate established by the operator while operating the manual mixing valve 8.

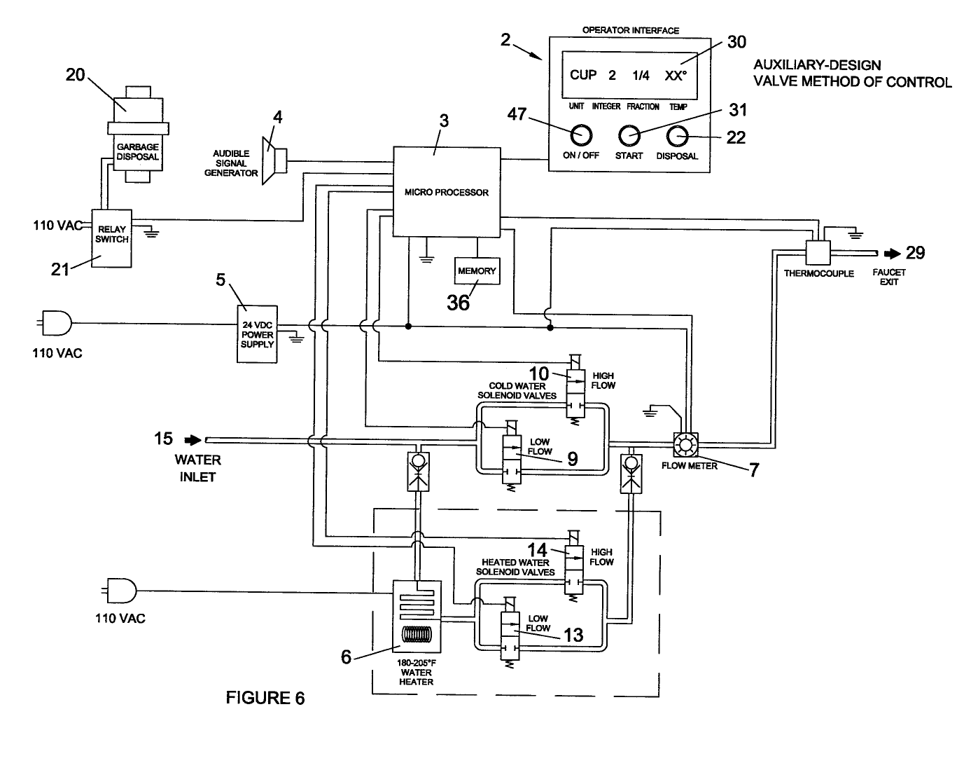

Referring to FIG. 6, a garbage disposal input switch 22 is provided for the operator to initiate the operation of a garbage disposal 20 by the programmable controller 3 generating a garbage disposal control signal to an actuator means 21. The garbage disposal input switch 22 may be an electromechanical relay or solid-state relay or other means for converting the programmable controller low voltage signal into a high-voltage, high-current signal sufficient for operating the garbage disposal. The programmable controller 3 detects the operator's desire to operate the garbage disposal by sensing the operator activating the garbage disposal input switch 22. The programmable controller 3 then verifies sufficient liquid is flowing from the faucet exit 29 by reading the flow meter values indicating the volume of liquid flowing through the faucet exit 29. It is know within the industry that garbage disposal units should be operated with sufficient water flowing through the garbage disposal unit 20 to prevent damage.

The programmable controller 3 continues to monitor the flow meter values and will de-activate the garbage disposal control signal when the volume of liquid flowing through the faucet exit 29 is insufficient to prevent damage to the garbage disposal unit 20.

The programmable controller 3 may also be operated in a mode where the operator enables the garbage disposal. The programmable controller 3 will then activate and de-activate the garbage disposal control signal as the flow of liquid through the faucet exit 29 is of sufficient volumes to prevent damage to the garbage disposal unit 20. This allows the operator to control the garbage disposal unit 20 by operating the manual mixing valve 8. The programmable controller 3 may include a delay in the garbage disposal control signal after sufficient liquid is flowing to allow the liquid to travel through the sink and into the garbage disposal unit 20. A different delay interval may be used by the programmable controller 3 when de-activating the garbage disposal unit 20 once the liquid flow is terminated through the faucet exit 29.

The Auxiliary-design electronic kitchen dispensing faucet apparatus 1 as shown in FIGS. 6 & 7 retrofits onto an existing kitchen sink and faucet assembly. An auxiliary faucet spigot 46 is attached to the sink assembly 45. The auxiliary faucet spigot 46 is attached to the first flow meter 7 and temperature sensing means 19. The first source of liquid 15 may be dispensed through the electronic kitchen dispensing faucet apparatus 1 or heated in the reservoir 6 and dispensed. The electronic kitchen dispensing faucet 1 may mix the first source liquid and heated reservoir liquid to achieve the desired operator dispensed liquid temperature.

Referring to FIG. 6, an Auxiliary-design electronic kitchen dispensing faucet 1 is shown with a first source of liquid 15, a heating reservoir 6, a programmable controller 3, an operator input 2, a first flow meter 7, a temperature sensor 19, and first, second, third, and fourth electric solenoid valves 9, 10, 13, and 14 respectively. The faucet shown dispenses an operator-defined volume of a first liquid at an operator-defined temperature by actuating the valves 9, 10, 13, 14 in sequence, measuring the volume of liquid flowing through the first flow meter 7 and faucet exit 29, de-actuating the valves in sequence when the desired volume has been dispensed into the container 44.

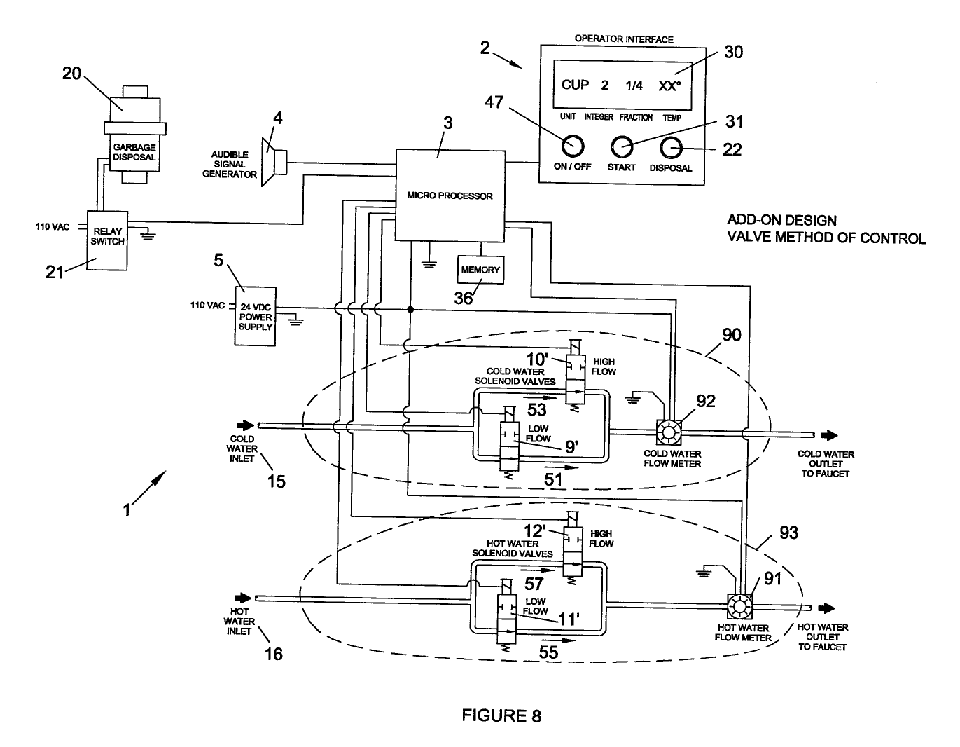

The Add-on electronic dispensing kitchen faucet shown in FIG. 8 may be used to retrofit a typical kitchen faucet and sink to allow dispensing of an operator-defined volume of liquid at an operator-specified temperature by actuating the electric solenoid valves 9′-12′ in sequence. The plumbing modifications to the typical kitchen sink 45 are shown in FIG. 9.

Continuing to refer to FIG. 8, the electronic dispensing kitchen faucet apparatus for converting a typical kitchen faucet into a dispensing faucet includes a first circuit 90, a second circuit 91, a programmable controller 3, and a operator input 2. The first circuit 90 being adapted for connection between a first source of liquid 15 to dispense liquid from the first source at first and second flow rates 51 and 53, respectively and adapted for connection to the typical kitchen faucet cold water source inlet 15. The first circuit 90 includes a first and second valve 9′ and 10′, respectively, for controlling the flow of the liquid from the first source through the first circuit 90, and a first flow meter 92 for measuring the volume of first source liquid flowing through the first circuit 90 and into the typical kitchen faucet cold water source inlet 15.

The second circuit 91 being adapted for connection between a second source of liquid 16 to dispense liquid from the second source at third and fourth flow rates 55 and 57, respectively and adapted for connection to the typical kitchen faucet hot water source inlet 16. The second circuit 91 includes a third and fourth valve 11′ and 12′, respectively, for controlling the flow of the liquid from the second source through the second circuit 91, and a second flow meter 93 for measuring the volume of second source liquid through the second circuit 93 and into the typical kitchen faucet hot water source inlet 16.

The first, second, third and fourth valves 9′, 10′, 11′, and 12′ are of a normally open design which allows liquid to flow from the inlet to the outlet port without a signal applied. When the signal is applied to the normally open valve, the valve flow path is blocked, restricting liquid from flowing between the inlet and outlet ports.

The outlet ports of the first and second valves 9′, 10′ are connected together and in fluid connection with the inlet of the first flow meter 92. The first flow meter 92 outlet is in fluid connection with the typical kitchen faucet cold water source inlet 15, typically referred to as the cold water source. The inlet ports of the first and second electric solenoid valves are connected together and in fluid connection with the first source liquid 15.

The outlet ports of the third and fourth valves 11′, 12′ are connected together and in fluid connection with the inlet of the second flow meter 91. The second flow meter 91 outlet is in fluid connection with the typical kitchen faucet hot water source inlet 16. The inlet ports of the third and fourth valves 11′, 12′ are connected together and in fluid connection with the second source liquid 16.

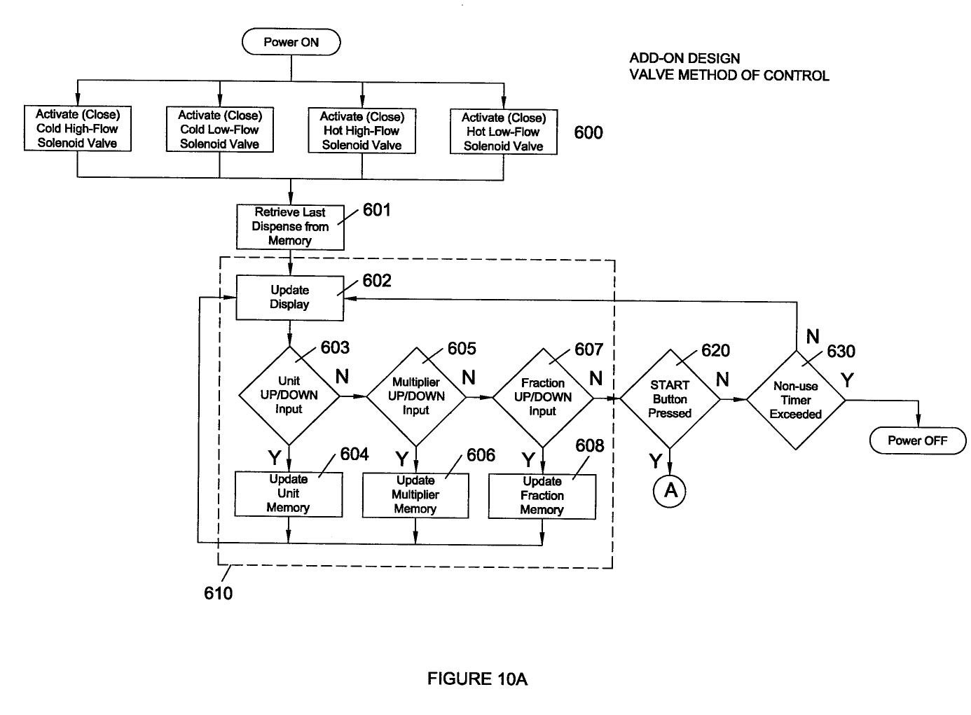

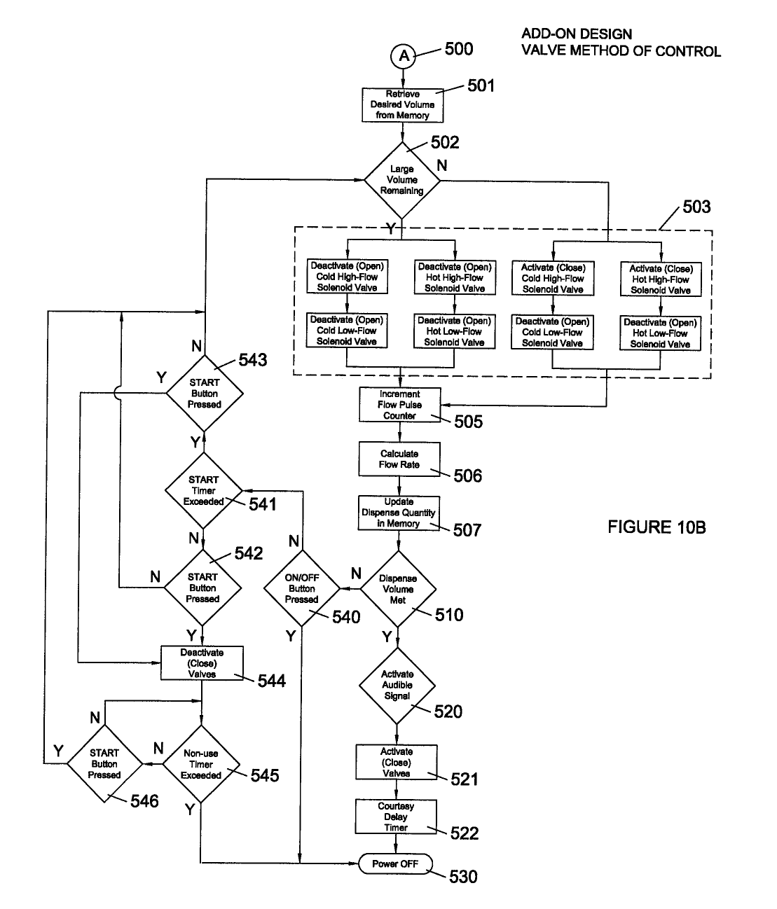

The programmable controller 3 generates output signals to control the first, second, third, and fourth valves 9′-12′. The operator input 2 includes an on/off input switch 47 which turns the electronic kitchen dispensing faucet on and off. When the on/off input switch 47 is depressed, the electronic kitchen faucet apparatus 1 is turned on. The first, second, third, and fourth electric solenoid valves 9′-12′ are actuated as shown in FIG. 10A step 600, terminating flow of the first and second liquid 15 and 16, respectively, through the faucet exit 29, thereby enabling the dispensing of an operator desired volume of liquid as shown in step 610. The programmable controller 3 generates an audible control signal which activates the audible signal generator 4 to inform the operator the electronic kitchen dispensing faucet apparatus 1 has closed the electric solenoid valves thereby stopping the flow of the first and second source liquid through the faucet exit 29. The programmable controller 3 also displays a message to the operator on the operator display 30 indicating the operator must open the manual mixing valve to allow the measured volume of liquid to flow from the faucet exit 29.

When the start input switch is actuated as shown in FIG. 10A step 620, the desired volume of liquid is dispensed from the faucet exit 29. The programmable controller 3 calculates the pulse rate of the first, second, third, and fourth valves 9′-12′ needed to flow the desired volume of liquid desired by the operator.

If no activity occurs on the operator input within the non-use timer interval as shown in FIG. 10A step 630, the programmable controller 3 will generate an audible control signal to the audible signal generator 4 to inform the operator that the faucet apparatus 1 will be turned off and the valves 9′-12′ will be de-actuated. If the operator left the manual mixing valve in the open position, the first and second source liquids 15, 16 would flow through the faucet exit 29.

The operator input 2 allows the operator to select the desired volume of liquid to be dispensed as shown in FIG. 10A step 610.

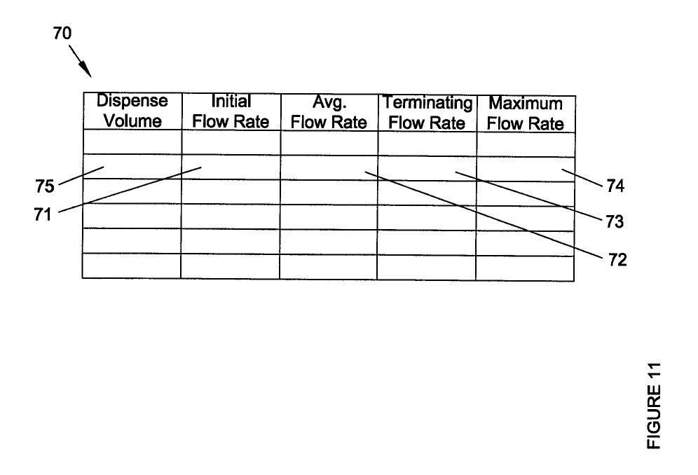

The liquid flow rate through the faucet exit 29 is increased slowly to insure the liquid does not splash out of the container 44 or result in the containers ensuing mixture gushing out as the liquid begins to flow into the container 44. Referring to FIG. 11, the programmable controller 3 locates the desired volume of liquid 75 within a flow rate table of volumes 70 stored in memory 36. The values for the initial, terminating, average, and maximum flow rates 71, 72, 73, 74, respectively, are extracted from the flow rate table 70 stored in memory 36. The initial, terminating, average, and maximum flow rates 71-74 are based on the dispensed volume 75 and the anticipated container size to be used in collecting the volume dispensed. The flow rate table 70 also contains the initial and terminating flow rate volumes 71 and 73, respectively. The initial flow rate 71 is used when the programmable controller 3 initiates liquid flowing through the faucet exit 29. The initial flow rate 71 will be allowed to flow for up to the initial flow volume before increasing the flow rate to the average flow rate 72. The terminating flow rate 73 is used when the dispensed volume is within the terminating flow volume. The flow rate will be reduced to the terminating flow rate 73 while dispensing the terminating flow volume and therefore dispense the total operator input volume desired.

Once the initial flow volume has been dispensed, the programmable controller 3 increases the liquid flow rate to the average flow rate 72. The programmable controller 3 sequences the first, second, third, and fourth electric solenoid valves 9′-12′ to maintain the flow rate at approximately the average flow rate 72; but below the maximum flow rate 74. The first, second, third, and fourth electric solenoid valves 9′-12′ are actuated and de-actuated in sequence to maintain the liquid temperature at the desired operator temperature.

### MODIFICATION

Modified apparatus and systems are shown in FIGS. 12-16B, 17-21B, and FIG. 22. In the modified apparatus and systems, identical and similar components and features are identified using the same numbers . . . and substituted components are also identified using the same numbers but with the addition of a letter “A”, “B”, or “C”. This is done to reduce redundant discussion. It is noted that these modified apparatus and systems perform with the accuracy and repeatability of the previously described system.

### First Modification

The apparatus 1A (FIG. 12) for an All-in-One electronic dispensing kitchen faucet includes a base 48, a spout 49, a first circuit 50A, a first positive-displacement pump 10A, and a programmable controller 3. The base 48 is adapted for mounting to a kitchen sink 45. The spout 49 extends from the base 48 for dispensing the total amount of liquid. The first circuit is adapted for connection to a first source of liquid 15 to dispense liquid from the first source through the first circuit 50A.

The first positive-displacement pump 10A (FIG. 12) is connected to a first motor 9A. The first positive-displacement pump 10A generates a specific volume output for a given input. By activating the first positive-displacement pump 10A with the first motor 9A for a controlled number of rotations, it will accurately dispense a measured amount of first source liquid flowing through the faucet exit 29. Those skilled in the art will understand that a pump can be driven in different manners such as electric motor or electric solenoid and a scope of the present invention is believed to include these concepts.

The programmable controller 3 (FIG. 12) is operably connected to the first positive-displacement pump 10A through the first motor 9A. The controller 3 is programmed and adapted to output first signals to the first motor 9A. The controller 3 generates control signals to activate the first motor 9A, driving the first positive-displacement pump 10A to dispense an accurate total amount of liquid from the spout 49.

The first motor 9A is capable of operating at a varying rotational velocity in response to the control signal from the controller 3. The controller 3 generates a control signal to activate the first motor 9A at a given speed to control the first flow rate 51.

Another embodiment of the apparatus 1A for an electronic dispensing kitchen faucet includes a first motor 9A, a first positive-displacement pump 10A, an operator input device 2, a start input switch 31, and a programmable controller 3.

The operator input device 2 allows the operator to specify the volume of liquid desired, as well as other parameters, settings, and values useful for liquid dispensing. The operator input contains a display 30 for communicating information to the operator such as volume dispensed, volume to be dispensed, temperature of the liquid being dispensed, and other parameters or settings. The parameters and settings are stored in memory 36 and used by the programmable controller 3 while operating the faucet apparatus 1A.

The start input switch is used to initiate liquid dispensing through the electronic kitchen dispensing faucet apparatus. When the start input switch 31 is depressed, the apparatus initiates dispensing. If the start input switch 31 is depressed while the apparatus is dispensing, the apparatus will pause the liquid dispensing pending further action by the operator. The liquid dispensing will complete the dispensing operation if the start input switch 31 is depressed while the apparatus 1A is paused.

The programmable controller 3 receives input from the operator input 2 and start input switch 31 and contains an audible signal generator 4 for alerting the operator of errors or when the liquid dispensing cycle is complete. The programmable controller 3 communicates with the operator by displaying information on the display 30. The programmable controller 3 generates control signals to initiate liquid flowing from the first source of liquid 15. These control signals actuate the first positive-displacement pump 10A to achieve the desired flow rate through the faucet apparatus 1A.

The programmable controller 3 generates a signal representing the volume of liquid flowing. The controller 3 sums the signals and compares the total volume dispensed to the desired operator volume input. The controller 3 generates control signals to the first positive-displacement pump 10A to stop the flow of liquid when the desired volume of liquid has been dispensed from the faucet apparatus 1A into the container 44.

Many examples of positive-displacement pumps are commercially available. A positive-displacement pump of type used in this application is any pump that has an expanding cavity on the inlet side of the pump and a decreasing cavity on the outlet side. Liquid flows into the inlet as the cavity is expanding and the liquid is forced out the outlet side as the cavity collapses. Some types include: peristaltic, diaphragm, piston, rotary lobe, screw, flexible impeller, gear, or vane. It should be noted that any of these types of pump designs may be equally substituted for producing the volume of liquid flowing through the faucet outlet. Those skilled in the art will also understand that a pump can be driven in different manners such as electric motor or electric solenoid and a scope of the present invention is believed to include these concepts.

The operator input 2 provides a means for the operator to specify the volume of first source liquid 15 to be dispensed from the faucet apparatus 1A, as discussed above. The operator input 2 also includes an audible signal generator 4, as discussed above. The input device 2 and its operation with the system 1A were previously described and the description of its operation need not be repeated.

The programmable controller 3 receives input signals from the operator input 2 and start input switch 31. The programmable control 3 produces control signals to the first motor 9A and display 30. The programmable controller 3 monitors the start input switch signal to initiate, pause, or stop the flow of liquid through the faucet as shown in FIGS. 5A and 5B. The programmable controller 3 generates a first control signal which actuates the first motor 9A driving the first positive-displacement pump 10A as needed to control the flow rate of the first source liquid dispensed from the faucet exit 29.

Continuing to refer to FIG. 12, the electronic kitchen dispensing faucet apparatus 1A may also include a second circuit 52A, a third circuit 54A, and a temperature sensor 19. The second circuit 52A is adapted for connection to a second source of liquid 16 to dispense liquid from the second source at a second flow rate 53A. The second circuit 52A includes a second motor 11A connected to a second positive-displacement pump 12A for controlling the flow of liquid from the second source through the second circuit 52A. The second motor 11A is capable of operating at a varying rotational velocity in response to the control signal from the controller 3. The controller 3 generates a control signal to activate the second motor 11A at a given speed to control the second flow rate 53A.

In apparatus 1A, the programmable controller 3 generates control signals that activate the first motor 9A, driving the first positive-displacement pump 10A and the second motor 11A, driving the second positive-displacement pump 12A resulting in liquid flowing through the corresponding circuit. The programmable controller 3 receives an electric voltage signal from the temperature sensor 19 representative of the liquid temperature dispensed from the faucet exit 29. The programmable controller 3 converts the temperature sensor electrical voltage into a dispensed liquid temperature. The programmable controller 3 then compares the dispensed liquid temperature to the desired operator temperature. The programmable controller calculates the rate for the first and second motors 9A, 11A to adjust the temperature and volume of liquid flowing from the faucet exit 29. The programmable controller 3 determines the magnitude of temperature error in the resultant liquid dispensed from the faucet and increases the flow rate in the temperature direction of adjustment required. The rate of the positive-displacement pump attached to the opposing temperature liquid source may be reduced if the flow rate exceeds the maximum flow rate for the volume being dispensed or if a greater temperature error exists.

Continuing to refer to FIG. 12, the electronic kitchen dispensing faucet apparatus 1A may also include a third circuit 54A and a heated liquid reservoir 6. The heated liquid reservoir 6 has an inlet and outlet, the inlet connected to the first source liquid 15A, the heated liquid reservoir 6 maintaining the temperature of the liquid in the reservoir at a temperature between 180 and 205 degrees Fahrenheit. The reservoir 6 heats the first source liquid 15 flowing into the reservoir. The reservoir 6 contains a heating element and temperature regulating means to maintain the liquid within the reservoir at an elevated temperature between 180 and 205 degrees Fahrenheit. The liquid stored within the reservoir becomes a third source liquid for dispensing from the electronic kitchen dispensing faucet.

The third circuit 54A is adapted for connection to the outlet of the heated liquid reservoir 6 to dispense hot liquid from the heated reservoir 6 at a third flow rate 55A. The third circuit 54A includes a third motor 13A, driving the third positive-displacement pump 14A for controlling the flow of hot liquid from the heated liquid reservoir 6 through the third circuit 54A. The third motor 13A is capable of operating at a varying rotational velocity in response to the control signal from the controller 3. The controller 3 generates a control signal to activate the second motor 13A at a given speed to control the third flow rate 54A.

The first, second, and third circuits 50A, 52A, 54A are connected together to form a common outlet circuit 26 and dispensed from the faucet exit 29.

The programmable controller 3 generates control signals that activate the first motor 9A to drive the first positive-displacement pump 10A, and the second motor 11A to drive the second positive-displacement pump 12A, and the third motor 13A to drive the third positive-displacement pump 14A, which results in liquid flowing through the circuit and being dispensed from the faucet exit 29. The programmable controller 3 receives an electric voltage signal from the temperature sensor 19 proportional to the liquid temperature dispensed from the faucet. The programmable controller 3 converts the temperature sensor electrical voltage into a dispensed liquid temperature. The programmable controller 3 then compares the dispensed liquid temperature to the operator desired liquid temperature. The programmable controller 3 calculates the rate needed for actuating the first, second, and third motors 9A, 11A, 13A to adjust the temperature and volume of liquid flowing through the faucet exit 29. The programmable controller 3 determines the magnitude of temperature error in the resultant liquid dispensed from the faucet and increases the flow rate in the temperature direction of adjustment required. The rate of the positive-displacement pump attached to the opposing temperature liquid source may be reduced if the flow rate exceeds the maximum flow rate for the volume being dispensed.

The programmable controller 3 determines the initial flow rate 71 (see FIG. 11) by comparing the operator input volume 75 to a table of volumes 70 with corresponding output flow rate parameters stored in memory 36. The programmable controller 3 selects the appropriate initial flow rate 71. The initial flow rate 71 limits the flow rate of liquid dispensed from the faucet exit 29 to insure the liquid does not splash or gush out of the container 44 used to capture the dispensed liquid. The output flow rate is also determined and limited by the total volume of liquid to be dispensed, and the actual volume of liquid dispensed from the faucet exit 29 into the container 44.

The flow rate through the positive-displacement pumps is reduced to a termination flow rate 73 when the actual volume dispensed is near the total volume desired by the operator to insure volumetric accuracy. The programmable controller 3 determines the termination flow rate 73 by comparing the operator input volume 75 to a table of volumes 70 with corresponding output flow rates stored in memory 36. The programmable controller 3 selects the appropriate terminating flow rate 73. The flow rate through the faucet exit 29 may be abruptly terminated as the total volume dispensed increases above a predefined volume. By abruptly terminating the flow of liquid, liquid volumes above this predefined volume are rapidly dispensed without compromising volumetric accuracy dispensed into the container.

The flow rate through the positive-displacement pumps is maintained at an average flow rate 72 while dispensing the source liquids when the volume dispensed is greater than the initial volume but less than the operator input volume less the termination volume. The programmable controller 3 determines the average flow rate 72 by comparing the operator input volume to a table of volumes 70 with corresponding output flow rates stored in memory 36. The programmable controller 3 selects the appropriate average flow rate 72.

The flow rate through the faucet exit 29 is limited to a maximum flow rate 74 whenever dispensing a measured volume of liquid. This maximum flow rate 74 is determined by the maximum flow rate of the positive-displacement pump. By limiting the flow rate through the faucet exit 29 to the maximum flow rate 74, the volumetric accuracy is insured.

Once the operator specified volume has been dispensed through the kitchen faucet or the dispensing operation suspended by the operator, the programmable controller 3 remains idle waiting for additional operator input. If no operator input is received within a selected time interval, the electronic kitchen dispensing faucet apparatus 1A will turn power off to the unit to conserve electricity and to turn off the operator display illumination source which could be annoying to the operator during the nighttime.

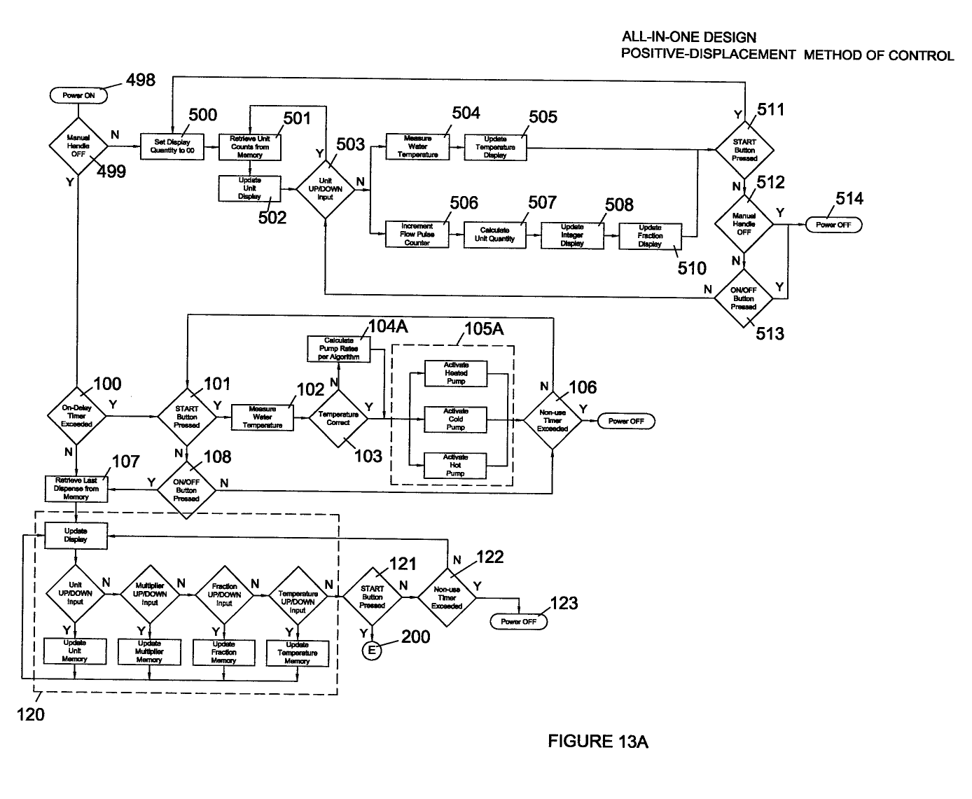

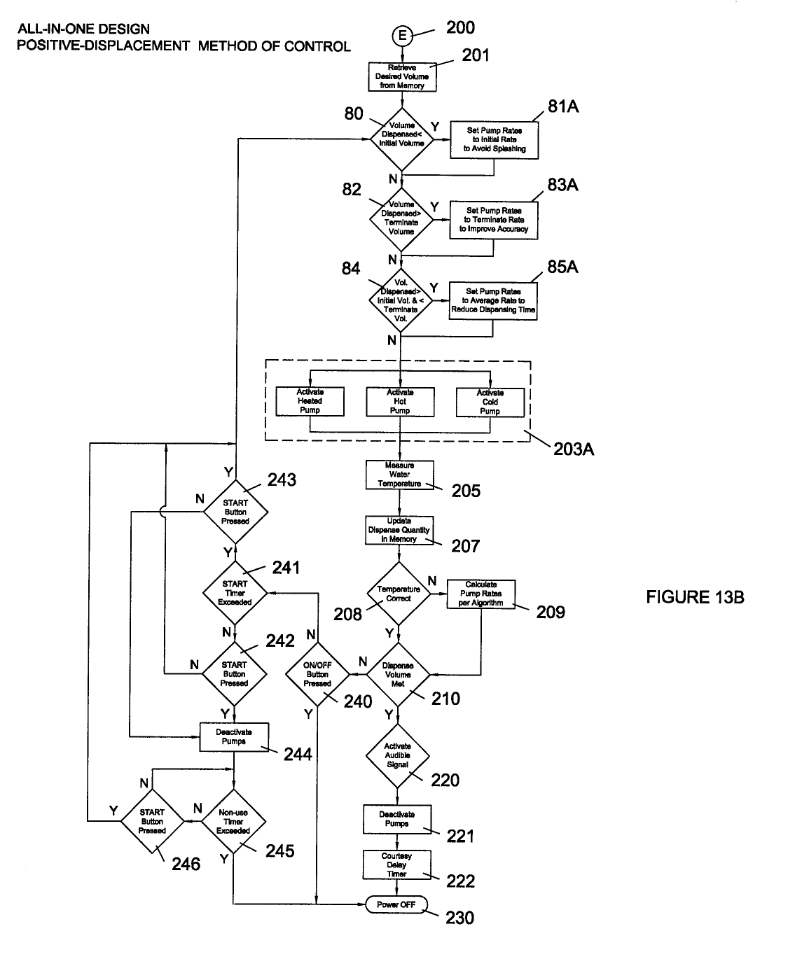

The flow chart of FIGS. 13A-13B are sufficiently similar to that of FIGS. 5A-5B, such that a detailed description is not required. It is noted that if the current temperature measured in step 102 is not at the desired value, the pump rate is adjusted in step 104a prior to the positive-displacement pumps being actuated 105a based on a rate calculated to maintain the average flow rate 72 and to regulate the liquid temperature flowing from the faucet exit 29 at the operator desired temperature. As long as the operator continues to hold the start input switch 31 depressed maintaining the start input signal activated 101, the flow of liquid through the faucet exit 29 continues. This cycle allows the operator to prime or preheat the faucet components with elevated temperature liquid to insure the desired liquid temperature is dispensed in a subsequent dispensing cycle. Also, if the start timer exceeds a preset value, the positive-displacement pumps will be actuated while the start input switch 31 remains depressed, activating the start input signal as shown in FIG. 13B, which will dispense liquid while the start input switch 31 is activated 243 or until the dispensed volume equals the dispensed volume 210.

If the start input switch 31 is de-activated before the start timer exceeds the preset value 241, the dispensing process continues as shown in FIG. 13B step 242, which dispenses liquid until the operator desired volume has been dispensed 210; or the start input switch 31 is activated 242. If the start input switch 31 signal is activated while liquid is flowing 242, the positive-displacement pumps are de-actuated which suspends liquid flowing through the faucet exit 29. When the operator depresses the start input switch 31 signal as shown in step 246, the liquid dispensing continues until the dispensed volume is dispensed 210 or the operator activates the On/Off input switch signal 240.

Now referring to FIG. 13B, the operator input stored volume of liquid to be dispensed is retrieved 201 from memory 36. The programmable controller 3 compares the volume to be dispensed to a predefined volume 82 to adjust the liquid flow rate based on the operator desired volume of liquid. If the dispensed volume is above the predefined volume, the positive-displacement pumps are actuated at a rate to dispense at a high flow rate. If the dispensed volume is below the predefined volume, the positive-displacement pumps are actuated at a rate to dispense at a lower flow rate as shown in step 84.

The accumulated total volume dispensed is stored in memory as shown in step 207. The temperature sensor 19 is read by the programmable controller 3 in step 205.

The current dispensed liquid temperature is compared to the desired operator input temperature in step 208. Each positive-displacement pump rate is adjusted based on the difference between the current temperature and desired temperature.

A table of frequently dispensed heated liquid volumes may be maintained in the memory 36. This table would include the predefined liquid volume and temperature, and optimal control information for controlling the pumps. The operator input 2 will allow the operator to select a predefined volume and temperature of heated liquid for measured dispensing from the electronic kitchen dispensing faucet apparatus 1A. These frequently dispensed volumes and temperatures are typical of pre-packaged food products like instant soups, tea, coffee, cocoa, or other hot beverages. The table of volumes and temperatures may be preprogrammed from the manufacturer or input by the operator and stored in memory 36 for future use.

To use the table of frequently dispensed heated liquid volumes and temperatures, the operator input would enable the selection from the table of heated volumes and temperatures. The operator would then scroll through each entry stored in memory 36. When the desired table entry is located by the operator, the operator would then select this entry for subsequent dispensing when the start input switch 31 is activated.

FIG. 12 also illustrates that the electronic kitchen dispensing faucet apparatus 1A may also include a manual mixing valve 8, a first and second flow meter 17 and 18 respectively for measuring the volume of the first and second source of liquids flowing through the faucet exit 29 as a result of the manual mixing valve actuation. The manual mixing valve 8 provides the means for the operator to infinitely adjust the flow rates of the first and second source liquids 15, 16 through the manual mixing valve 8 and to be dispensed from the faucet exit 29. This was previously discussed in regard to FIG. 1 and the discussion need not be repeated.

Notably, the operator can close the manual mixing valve 8, and using the operator input 2, select a total volume and temperature for dispensing by the electronic kitchen dispensing faucet apparatus 1A. The programmable controller 3 will calculate the remaining volume of liquid by subtracting the volume of liquid dispensed through the manual mixing valve from the desired volume selected from the operator input 2. The programmable controller 3 will then actuate the positive-displacement pumps to dispense the remaining volume of liquid from the faucet exit 29.

The programmable controller 3 may also sequence the positive-displacement pumps to complete the dispensing of liquid at the average temperature set by the operator using the manual mixing valve position. The programmable controller 3 may also sequence the positive-displacement pumps to complete the dispensing of liquid at the same flow rate established by the operator while operating the manual mixing valve 8.

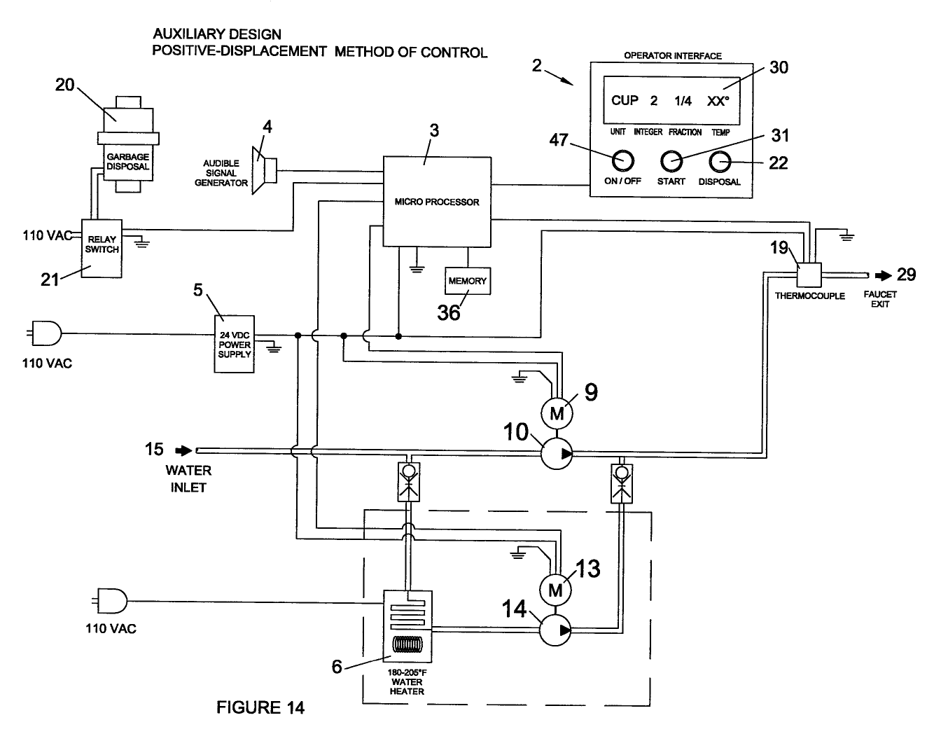

Referring to FIGS. 12 and 14, a garbage disposal input switch 22 may be connected to apparatus 1A (FIG. 12) as described above for apparatus 1 (FIG. 1).

FIG. 14 shows an Auxiliary-design electronic kitchen dispensing faucet 1A with a first source of liquid 15, a heating reservoir 6, a programmable controller 3, an operator input 2, a first positive-displacement pump 10A, a first motor 9A, a temperature sensor 19, a second positive-displacement pump 14A, and a second motor 13A. The faucet shown dispenses an operator-defined volume of a first liquid at an operator-defined temperature by activating the first motor 9A driving the first positive-displacement pump 10A and the second motor 13A driving the second positive-displacement pump 14A, measuring the volume and temperature of the liquid flowing through the faucet exit 29, and de-activating the pumps when the desired volume has been dispensed into the container 44.

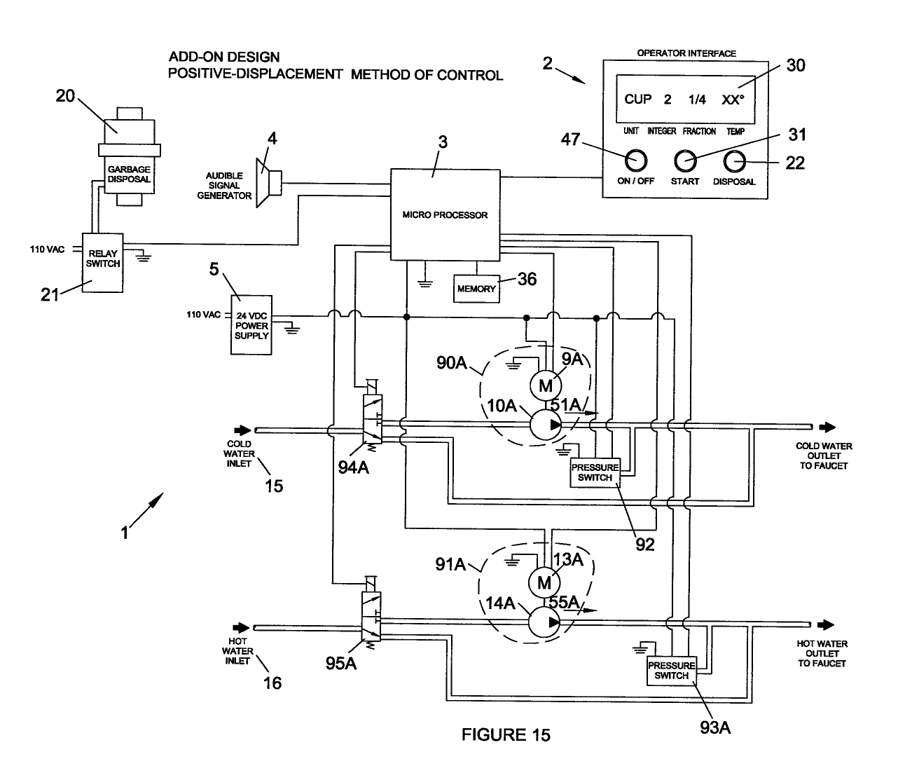

The Add-on electronic dispensing kitchen faucet shown in FIG. 15 may be used to retrofit a typical kitchen faucet and sink to allow dispensing of an operator-defined volume of liquid at an operator-specified temperature by activating the positive-displacement pumps 10A and 14A. The plumbing modifications for a typical kitchen sink 45 are shown in FIG. 9.

Continuing to refer to FIG. 15, the electronic dispensing kitchen faucet apparatus for converting a typical kitchen faucet into a dispensing faucet includes a first circuit 90A, a second circuit 91A, a programmable controller 3, and an operator input 2. The first circuit 90A is adapted for connection between a first source of liquid 15 to dispense liquid from the first source at a flow rate 51A and is adapted for connection to the typical kitchen faucet cold water source inlet 15. The first circuit 90A includes a first motor 9A and positive-displacement pump 10A for controlling the flow of the liquid from the first source through the first circuit 90A, and into the typical kitchen faucet cold water source inlet 15. A first pressure switch 92A is installed between the first positive-displacement pump 10A and the faucet outlet 29, and is monitored to disable the flow 51A if the faucet outlet 29 is obstructed.

The second circuit 91A being adapted for connection between a second source of liquid 16 to dispense liquid from the second source at a flow rate 55A and adapted for connection to the typical kitchen faucet hot water source inlet 16. The second circuit 91A includes a second motor 13A and positive-displacement pump 14A for controlling the flow of the liquid from the second source through the second circuit 91A, and into the typical kitchen faucet hot water source inlet 16. A second pressure switch 93A is installed between the second positive-displacement pump 14A and the faucet outlet 29, and is monitored to disable the flow 55A if the faucet outlet 29 is obstructed.

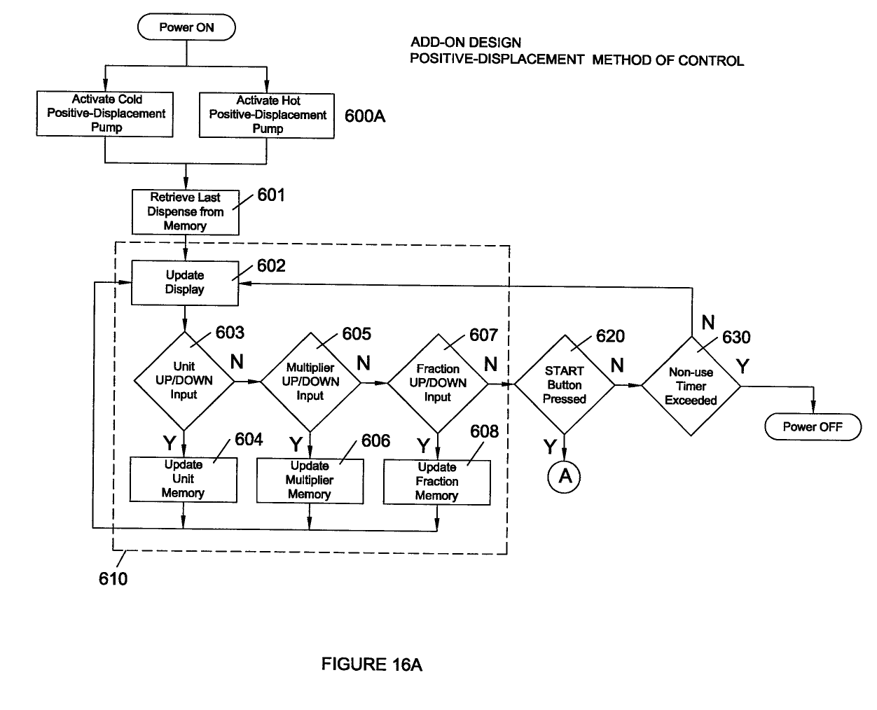

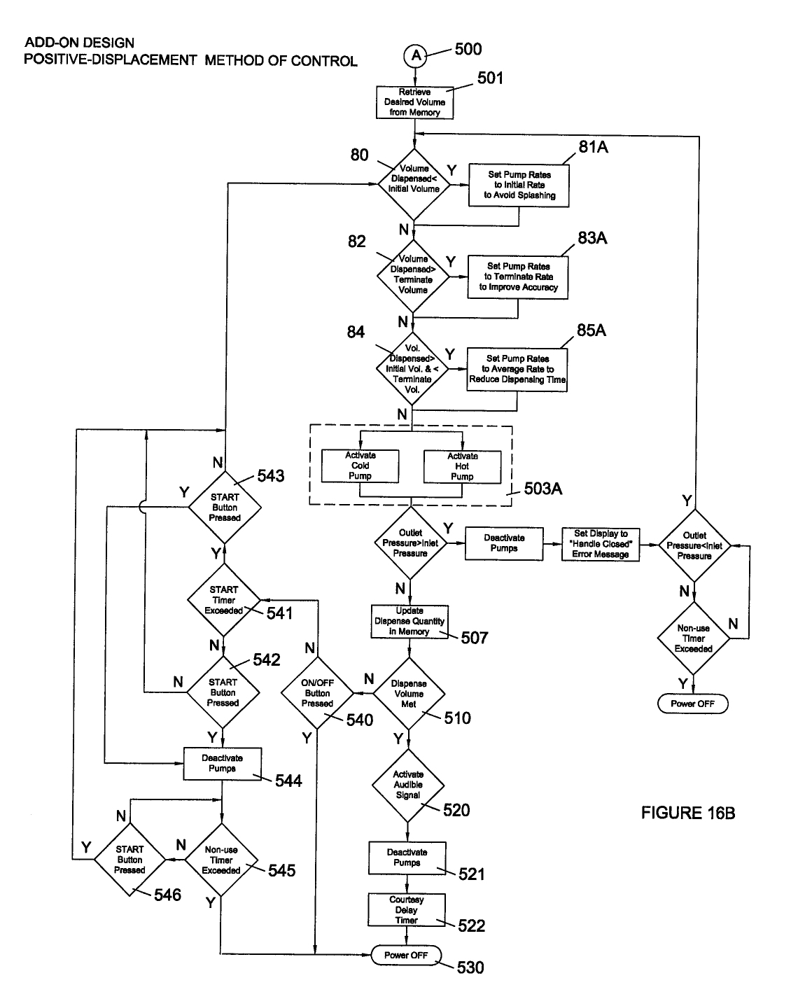

A first solenoid-operated directional control valve 94A (FIG. 15) is installed between the first circuit 90A and the cold water inlet 15. The first solenoid-operated directional control valve 94A is of a design that allows liquid to flow from the inlet port to either of two outlet ports. The first outlet port is installed to bypass the first circuit 90A when the electronic dispensing kitchen faucet apparatus 1A is off. When a signal is applied to the valve, the flow from the inlet port is directed to the second outlet port and through the first circuit 90A. A second solenoid-operated directional control valve 95A is installed between the second circuit 91A and the hot water inlet 16. The second solenoid-operated directional control valve 95A is of a design that allows liquid to flow from the inlet port to either of two outlet ports. The first outlet port is installed to bypass the first circuit 91A when the electronic dispensing kitchen faucet apparatus 1A is off. When a signal is applied to the valve, the flow from the inlet port is directed to the second outlet port and through the second circuit 91A. The programmable controller 3 generates output signals to control the first motor 9A, driving the first positive-displacement pump 10A and the second motor 13A, driving the second positive-displacement pump 14A. The operator input 2 includes an on/off input switch 47 which turns the electronic kitchen dispensing faucet on and off. When the on/off input switch 47 is depressed, the electronic kitchen faucet apparatus 1A is turned on. The first and second solenoid-operated directional control valves 94A and 95A are actuated as shown in FIG. 16A step 600A, terminating flow of the first and second liquid 15 and 16, respectively, through the faucet exit 29, thereby enabling the dispensing of an operator desired volume of liquid as shown in step 610. The programmable controller 3 generates an audible control signal which activates the audible signal generator 4 to inform the operator the electronic kitchen dispensing faucet apparatus 1A has activated the electric solenoid valves thereby stopping the flow of the first and second source liquid through the faucet exit 29. The programmable controller 3 also displays a message to the operator on the operator display 30 indicating the operator must open the manual mixing valve to allow the measured volume of liquid to flow from the faucet exit 29.

When the start input switch is actuated in step 620 (FIG. 16A), the desired volume of liquid is dispensed from the faucet exit 29. The programmable controller 3 calculates the rate of the positive-displacement pumps needed to flow the desired volume of liquid desired by the operator.

The liquid flow rate through the faucet exit 29 is controlled to slowly increase to insure that the liquid does not splash out of the container 44 or result in the containers ensuing mixture gushing out as the liquid begins to flow into the container 44. The programmable controller 3 locates the desired volume of liquid 75 within a flow rate table of volumes (see FIG. 11) stored in memory 36. The values for the initial, terminating, average, and maximum flow rates are extracted from the flow rate table stored in memory 36. The initial, terminating, average, and maximum flow rates are based on the dispensed volume and the anticipated container size to be used in collecting the volume dispensed.

Once the initial flow volume has been dispensed, the programmable controller 3 increases the liquid flow rate to the average flow rate. The programmable controller 3 generates control signals that activate the first motor 9A, driving the first positive-displacement pump 10A and the second motor 13A, driving the second positive-displacement pump 14A to maintain the flow rate at approximately the average flow rate; but below the maximum flow rate. The rate of the positive-displacement pumps 10A and 14A is controlled to maintain the liquid temperature at the desired operator temperature.

### Second Modification

The apparatus 1B (FIG. 17) for an All-in-One electronic dispensing kitchen faucet includes a base 48, a spout 49, a first circuit 50B, a first flow meter 10B, a first flow-restrictor apparatus 9, and a programmable controller 3. The base 48 is adapted for mounting to a kitchen sink 45. The spout 49 extends from the base 48 for dispensing the total amount of liquid. The first circuit being adapted for connection to a first pressurized source of liquid 15 to dispense liquid from the first source through the first circuit 50B.

The first flow meter 10B (FIG. 17) is connected to a first flow-restrictor apparatus 9B. The first flow meter 10B generates a first signal as a specific volume of liquid flows through the flow meter. By summing the signals generated by the flow meter 10B, the total volume flowing through circuit 50B and the faucet exit 29 may be calculated. After the Operator specified quantity of liquid is dispensed from the faucet exit, the first flow-restrictor apparatus 9B is signaled to terminate flow of the first pressurized source liquid 15 through the flow meter 10B.

The programmable controller 3 (FIG. 17) is operably connected to the first flow-restrictor apparatus 9B. The controller 3 is programmed and adapted to output first signals to the first flow-restrictor apparatus 9B. The controller may generate signals to the first flow-restrictor apparatus 9B to vary the resistance load to the flow meter 10B, thereby limiting the flow rate of the liquid flowing through the first circuit 50B. The controller may also generate signals to the first flow-restrictor apparatus 9B to restrict the movement of the flow meter 10B, thereby terminating the flow of liquid through the first circuit 50B.

The first pressurized source liquid 15 exerts pressure on the first flow meter 10B as it attempts to flow through the flow meter to the outlet port of the flow meter and to the dispensing faucet exit 29. Without a resistance load attached to the first flow meter, the source liquid would flow at a maximum free flow rate. The programmable controller 3 varies the resistance load to the flow meter 10B by increasing or decreasing the load placed on the flow-restrictor apparatus 9B. As the load is increased, the resistance to the flow meter is likewise increased, thereby causing the flow rate of the liquid flowing through the first circuit to be reduced. The programmable controller 3 may reduce the load placed on the flow-restrictor apparatus to increase the flow rate of liquid in the first circuit. Once the programmable controller reduces the load to zero, the maximum free flow rate of liquid through the first circuit is achieved.

In some variations of the invention, the programmable controller 3 may include the ability to increase the flow rate through the first circuit above the maximum free flow rate by changing the signals to the flow-restrictor apparatus 9B to create a pumping action. The flow-restrictor apparatus 9B would then force the flow meter 10B to operate as a pump, thereby increasing the pressure of the first source liquid and resulting in a higher flow rate through the first circuit. As the programmable controller 3 increases the signal rate to the flow-restrictor apparatus 9B, the flow rate through the flow meter 10B increases.

In some variations of the invention, the common output liquid circuit includes a solenoid valve 56B for terminating the flow of liquid through the flow meter 10B and dispensed from the faucet exit 29. The solenoid valve may be used on flow meters that may not completely terminate the flow of liquid once the flow meter is restricted from movement. Certain styles of flow meter designs allow a slight leakage due to the incomplete sealing surfaces, while other designs provide a complete seal thereby terminating the flow of liquid and slight leakage while the flow meter is restricted from operating.

By monitoring and summing the signals received from the flow meter 10B, the programmable controller 3 may determine the total volume of liquid dispensed from the faucet 29.

The first flow meter 10B may be one of several flow meter designs known within the industry. The flow meter may be of a lobe, gear, nutating disk, single or dual-action piston, single or double screw, vane or progressive cavity design. Each of these designs is capable of measuring a known volume of liquid based on a mechanical reaction to the liquid flowing though the flow meter. This mechanical movement may be measured or controlled external to the flow meter fluidic cavity. By attaching the flow-restrictor apparatus to the mechanical movement within the flow meter, a load may be applied that resists movement and subsequent flow of liquid through the circuit. The attachment of the flow-restrictor apparatus may be either a direct or indirect attachment means. Several means for indirect attachment exist; however, the preferred method is by electromagnetic coupling between the external load restrictor apparatus and the flow meter's moving parts.

In some variations, the flow-restrictor apparatus may be attached to the mechanical action within the flow meter and controlled so that a pumping action is applied to the flow meter and increases the flow rate of liquid within the flow meter and connected circuit. The attachment of the flow-restrictor apparatus for operating the flow meter as a pump may be either direct or indirect attachment means. Several means for indirect attachment exist; however, the preferred method is by electromagnetic coupling between the external flow-restrictor apparatus and the flow meter's moving parts.

The first flow-restrictor apparatus 9B may be one of several known variable and adjustable designs. A variable, adjustable mechanical friction brake or governor device may be used to adjust the flow of liquid through the first flow meter. However, the preferred embodiment is an electronic or electromechanical design. These electronic or electro-mechanical designs are more easily adapted to allow for the instantaneous switching between a variable load applied to the flow meter and for creating a more variable and dynamic load that is responsive to the signals received from the flow meter indicating the amount of liquid flowing within the circuit. These electronic and electromechanical designs are also more suitable for operating the flow-restrictor apparatus as a pump motor when attached to the flow meter. There are several electric motor arrangements that may be operated as a load and then switched to a pump motor arrangement. These motor types include stepper motors, DC voltage motors, synchronous or servo motors.

The programmable controller 3 is operably connected to the first flow meter 10B through the first flow-restrictor apparatus 9B. The controller 3 is programmed and adapted to output first signals to the first flow-restrictor apparatus 9B. The controller 3 generates control signals to activate the first flow-restrictor apparatus 9B, restricting the flow of liquid through the first flow meter 10B to dispense an accurate total amount of liquid from the spout 49.

The first flow-restrictor apparatus 9B is capable of operating at a varying rotational velocity in response to the control signal from the controller 3. The controller 3 generates a control signal to activate the first flow-restrictor apparatus 9B at a given speed to control the first flow rate 51B.

Another embodiment of the apparatus 1B for an electronic dispensing kitchen faucet includes a first flow meter 10B, a first flow-restrictor apparatus 9B, an operator input device 2, a start input switch 31, and a programmable controller 3.

The operator input device 2 allows the operator to specify the volume of liquid desired, as well as other parameters, settings, and values useful for liquid dispensing. The operator input contains a display 30 for communicating information to the operator such as volume dispensed, volume to be dispensed, temperature of the liquid being dispensed, and other parameters or settings. The parameters and settings are stored in memory 36 and used by the programmable controller 3 while operating the faucet apparatus 1B.

The start input switch is used to initiate liquid dispensing through the electronic kitchen dispensing faucet apparatus. When the start input switch 31 is depressed, the apparatus initiates dispensing. If the start input switch 31 is depressed while the apparatus is dispensing, the apparatus will pause the liquid dispensing pending further action by the operator. The liquid dispensing will complete the dispensing operation if the start input switch 31 is depressed while the apparatus 1B is paused.

Now continuing to refer to FIG. 17, the programmable controller 3 receives input from the operator input 2 and start input switch 31 and contains an audible signal generator 4 for alerting the operator of errors or when the liquid dispensing cycle is complete. The programmable controller 3 communicates with the operator by displaying information on the display 30. The programmable controller 3 generates control signals to initiate liquid flowing from the first source of liquid 15. These control signals to the flow-restrictor apparatus reduce the load on the flow meter 10B, allowing liquid to flow within the first circuit 50B. The control signals are adjusted to the flow-restrictor apparatus 9B to achieve the desired flow rate through the faucet apparatus 1B.

The first flow meter 10B generates a signal representing the volume of liquid flowing. The controller 3 sums the signals and compares the total volume dispensed to the desired operator volume input. The controller 3 generates control signals to the flow-restrictor apparatus 9B to stop the flow of liquid when the desired volume of liquid has been dispensed from the faucet apparatus 1B into the container 44.

The operator input 2 provides a means for the operator to specify the volume of first pressurized source liquid 15 to be dispensed from the faucet apparatus 1B, as previously described. The operator input 2 also includes an audible signal generator 4, as discussed above. The input device 2 and its operation with the system 1B were previously described and the description of its operation need not be repeated.

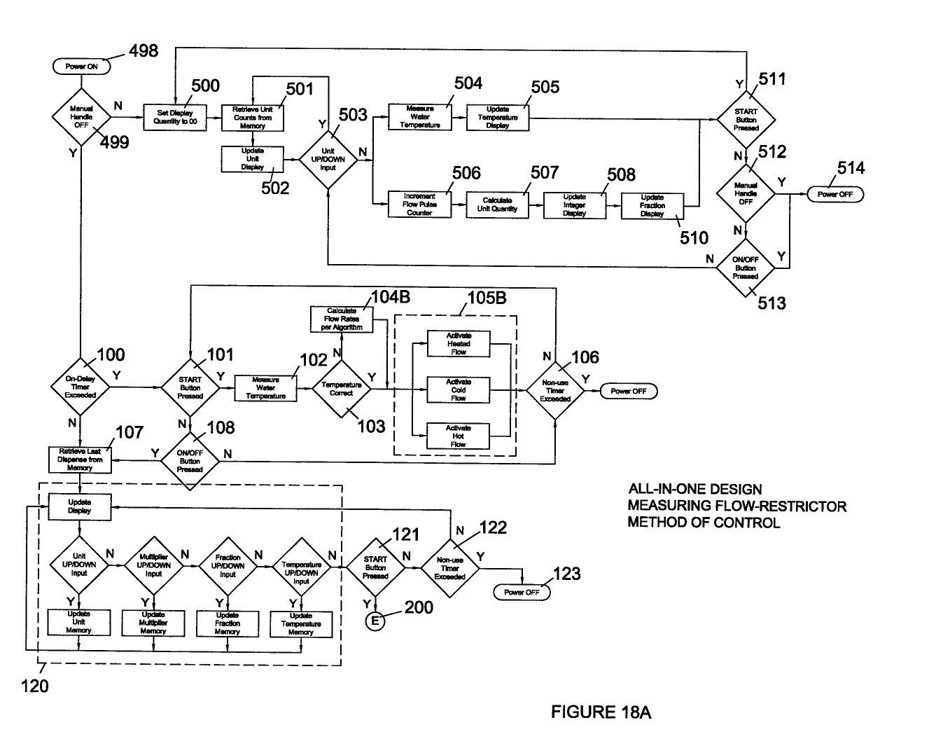

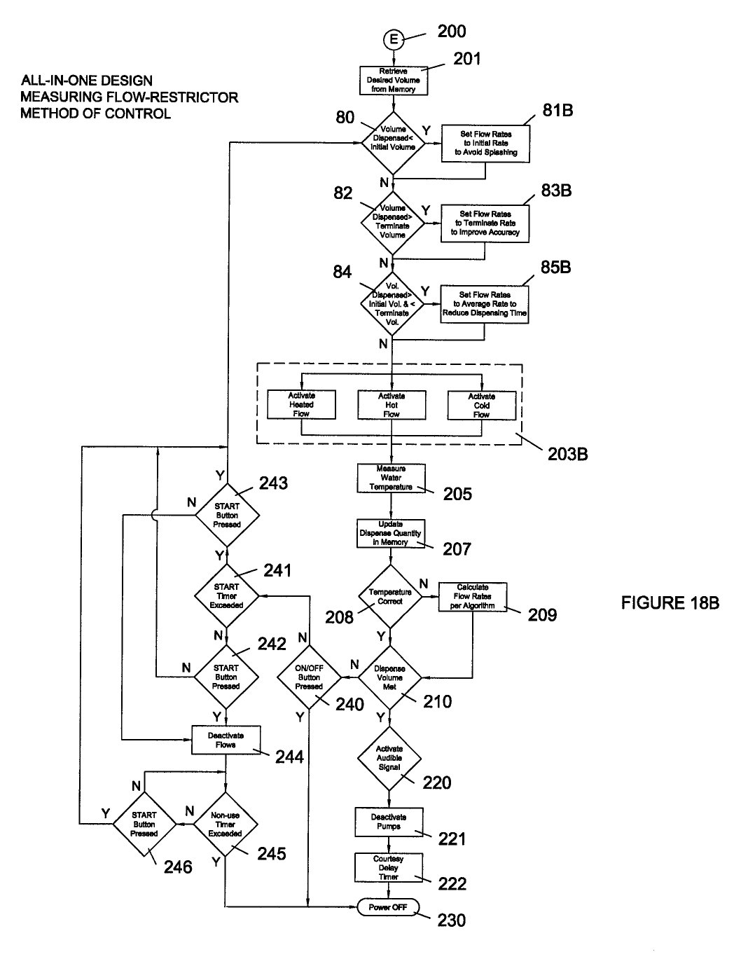

The programmable controller 3 receives input signals from the, operator input 2 and start input switch 31. The programmable control 3 produces control signals to the first flow-restrictor apparatus 9B and display 30. The programmable controller 3 monitors the start input switch signal to initiate, pause, or stop the flow of liquid through the faucet as shown in FIGS. 18A and 18B. The programmable controller 3 generates a first control signal which actuates the first flow-restrictor apparatus 9B allowing liquid to flow through the first flow meter 10B. The controller adjusts the first control signal as needed to control the flow rate of the first pressurized source liquid 15 dispensed from the faucet exit 29.

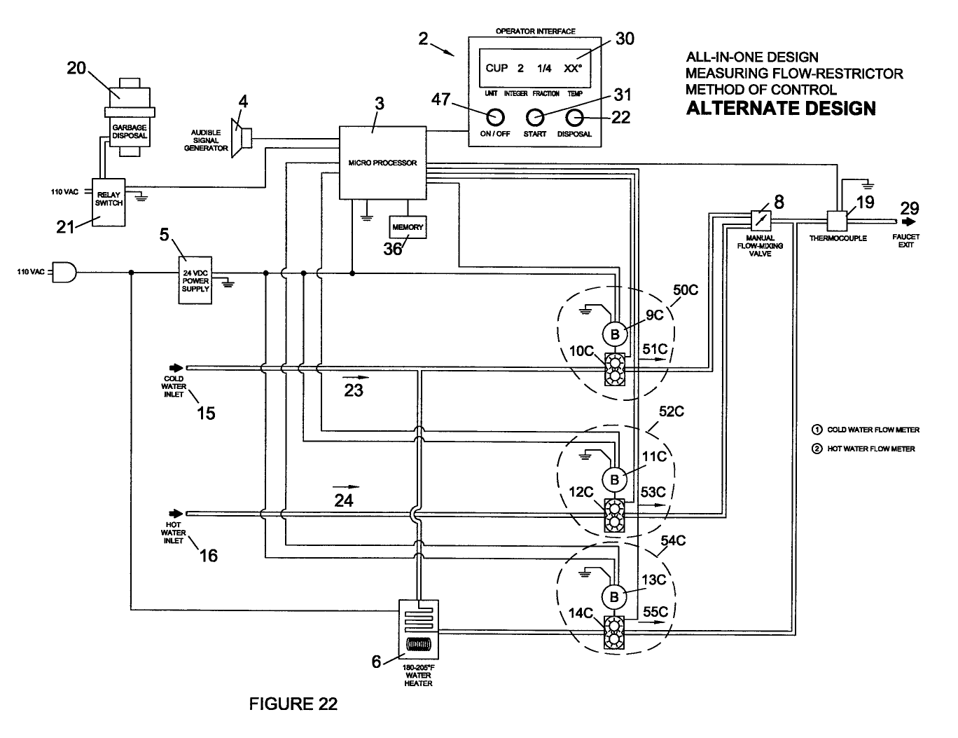

An alternative start input signal may initiate liquid dispensing through the electronic kitchen dispensing faucet apparatus as shown in FIG. 22. The controller 3 receives a signal from the flow meter 10B when liquid is allowed to flow through a manual mixing valve 8 when the operator opens the manual mixing valve indicating they are ready to dispense the desired volume of liquid into the container 44. The controller uses the flow meter 10 signal to initiate a dispensing cycle of the desired liquid. The controller 3 may detect the ratio of the flow rates 51B and 52B to compensate for the operators desired flow rate. The controller 3 may also detect if the operator terminates the flow of liquid prior to the desired volume of liquid being dispensed from the faucet exit.

Continuing to refer to FIG. 17, the electronic kitchen dispensing faucet apparatus 1B may also include a second circuit 52B, a third circuit 54B, and a temperature sensor 19. The second circuit 52B is adapted for connection to a second pressurized source of liquid 16 to dispense liquid from the second pressurized source at a second flow rate 53B. The second circuit 52B includes a second flow-restrictor apparatus 11B connected to a second flow meter 12B for controlling the flow of liquid from the second source through the second circuit 52B.

The second flow-restrictor apparatus 11B is capable of operating at a varying rotational velocity in response to the control signal from the controller 3. The controller 3 generates a control signal to activate the second flow-restrictor apparatus 11B at a given speed to control the second flow rate 53B. The controller 3 may operate the flow-restrictor apparatus 11B in several ways so that the flow of liquid dispensed is at the desired flow rate and produces the desired total volume dispensed. The controller 3 may produce a signal to the flow-restrictor apparatus that results in a resistive load placed on the flow meter, thereby limiting the flow of liquid through the circuit. The controller 3 may produce a signal to the flow-restrictor apparatus that restricts the flow meter from operating, thereby terminating the flow of liquid through the circuit. In some variations of the invention, the controller 3 may produce a signal to the flow-restrictor apparatus that creates a pumping action to the flow meter, thereby increasing the flow of liquid through the circuit.

In apparatus 1B, the programmable controller 3 generates control signals that activate the first flow-restrictor apparatus 9B and second flow-restrictor apparatus 11B, allowing liquid to flow through the first flow meter 10B and second flow meter 12B respectively and through the corresponding circuit. The programmable controller 3 receives an electric voltage signal from the temperature sensor 19 representative of the liquid temperature dispensed from the faucet exit 29. The programmable controller 3 converts the temperature sensor electrical voltage into a dispensed liquid temperature. The programmable controller 3 then compares the dispensed liquid temperature to the desired operator temperature. The programmable controller calculates the rate for the first and second flow-restrictor apparatus 9B, 11B to adjust the temperature and volume of liquid flowing from the faucet exit 29. The programmable controller 3 determines the magnitude of temperature error in the resultant liquid dispensed from the faucet and increases the flow rate in the temperature direction of adjustment required. The rate of flow through the flow meter attached to the opposing temperature liquid source may be reduced if the flow rate exceeds the maximum flow rate for the volume being dispensed or if a greater temperature error exists.

Continuing to refer to FIG. 17, the electronic kitchen dispensing faucet apparatus 1B may also include a third circuit 54B and a heated liquid reservoir 6. The heated liquid reservoir 6 has an inlet and outlet, the inlet connected to the first pressurized source liquid 15, the heated liquid reservoir 6 maintaining the temperature of the liquid in the reservoir at a temperature between 180 and 205 degrees Fahrenheit. The reservoir 6 heats the first pressurized source liquid 15 flowing into the reservoir. The reservoir 6 contains a heating element and temperature regulating means to maintain the liquid within the reservoir at an elevated temperature between 180 and 205 degrees Fahrenheit. The liquid stored within the reservoir becomes a third pressurized source liquid for dispensing from the electronic kitchen dispensing faucet.

An alternative start input signal may initiate liquid dispensing through the electronic kitchen dispensing faucet apparatus as shown in FIG. 17. The controller 3 receives a signal from the first or second flow meters 17B, 18B when liquid is allowed to flow through a manual mixing valve 8 when the operator opens the manual mixing valve indicating they are ready to dispense the desired volume of liquid into the container 44. The controller uses the signals from the flow meters 17B, 18B to initiate a dispensing cycle of the desired liquid. The controller 3 may detect the ratio of the flow rates 51B and 53B to compensate for the operators desired flow rate. The controller 3 may also detect if the operator terminates the flow of liquid prior to the desired volume of liquid being dispensed from the faucet exit.

The third circuit 54B is adapted for connection to the outlet of the heated liquid reservoir 6 to dispense hot liquid from the heated reservoir 6 at a third flow rate 55B. The third circuit 54B includes a third flow-restrictor apparatus 13B connected to a third flow meter 14B for controlling the flow of hot liquid from the heated liquid reservoir 6 through the third circuit 54B. The third flow-restrictor apparatus 13B is capable of operating at a varying rotational velocity in response to the control signal from the controller 3. The controller 3 generates a control signal to activate the third flow-restrictor apparatus 13B at a given speed to control the third flow rate 54B. The controller 3 may operate the flow-restrictor apparatus 13B in several ways so that the flow of liquid dispensed is at the desired flow rate and produces the desired total volume dispensed. The controller 3 may produce a signal to the flow-restrictor apparatus that results in a resistive load placed on the flow meter, thereby limiting the flow of liquid through the circuit. The controller 3 may produce a signal to the flow-restrictor apparatus that restricts the flow meter from operating, thereby terminating the flow of liquid through the circuit. In some variations of the invention, the controller 3 may produce a signal to the flow-restrictor apparatus that creates a pumping action to the flow meter, thereby increasing the flow of liquid through the circuit.

The first, second, and third circuits 50B, 52B, 54B are connected together to form a common outlet circuit 26.

The programmable controller 3 generates control signals that activate the first, second, and third flow-restrictor apparatus 9B, 11B, and 13B, respectively, allowing liquid to flow through the first, second, and third flow meters 10B, 12B, and 14B, respectively and through the corresponding circuit. The programmable controller 3 receives an electric voltage signal from the temperature sensor 19 representative of the liquid temperature dispensed from the faucet exit 29. The programmable controller 3 converts the temperature sensor electrical voltage into a dispensed liquid temperature. The programmable controller 3 then compares the dispensed liquid temperature to the desired operator temperature. The programmable controller calculates the rate for the first, second, and third flow-restrictor apparatus 9B, 11B, and 13B, respectively to adjust the temperature and volume of liquid flowing from the faucet exit 29. The programmable controller 3 determines the magnitude of temperature error in the resultant liquid dispensed from the faucet and increases the flow rate in the temperature direction of adjustment required. The rate of flow through the flow meter attached to the opposing temperature liquid source may be reduced if the flow rate exceeds the maximum flow rate for the volume being dispensed or if a greater temperature error exists.

The programmable controller 3 determines the initial flow rate 71 (see FIG. 11) by comparing the operator input volume 75 to a table of volumes 70 with corresponding output flow rate parameters stored in memory 36. The programmable controller 3 selects the appropriate initial flow rate 71. The initial flow rate 71 limits the flow rate of liquid dispensed from the faucet exit 29 to insure the liquid does not splash or gush out of the container 44 used to capture the dispensed liquid. The output flow rate is also determined and limited by the total volume of liquid to be dispensed, and the actual volume of liquid dispensed from the faucet exit 29 into the container 44.

The flow rate through the flow meters is reduced to a termination flow rate 73 when the actual volume dispensed is near the total volume desired by the operator to insure volumetric accuracy. The programmable controller 3 determines the termination flow rate 73 by comparing the operator input volume 75 to a table of volumes 70 with corresponding output flow rates stored in memory 36. The programmable controller 3 selects the appropriate terminating flow rate 73. The flow rate through the faucet exit 29 may be abruptly terminated as the total volume dispensed increases above a predefined volume. By abruptly terminating the flow of liquid, liquid volumes above this predefined volume are rapidly dispensed without compromising volumetric accuracy dispensed into the container.

The flow rate through the flow meters is maintained at an average flow rate 72 while dispensing the source liquids when the volume dispensed is greater than the initial volume but less than the operator input volume less the termination volume. The programmable controller 3 determines the average flow rate 72 by comparing the operator input volume to a table of volumes 70 with corresponding output flow rates stored in memory 36. The programmable controller 3 selects the appropriate average flow rate 72.

The flow rate through the faucet exit 29 is limited to a maximum flow rate 74 whenever dispensing a measured volume of liquid. This maximum flow rate 74 is determined by the maximum first flow meter characteristics. By limiting the flow rate through the faucet exit 29 to the maximum flow rate 74, the volumetric accuracy is insured.

Once the operator specified volume has been dispensed through the kitchen faucet or the dispensing operation suspended by the operator, the programmable controller 3 remains idle waiting for additional operator input. If no operator input is received within a selected time interval, the electronic kitchen dispensing faucet apparatus 1B will turn power off to the unit to conserve electricity and to turn off the operator display illumination source which could be annoying to the operator during the nighttime.

The flow chart of FIGS. 18A and 18B are sufficiently similar to that of FIGS. 5A-5B such that a detailed description is not required. It is noted that if the current temperature measured in step 102 is not at the desired value, the flow rate is adjusted 104B prior to the flow-restrictor apparatus being actuated 105B based on a rate calculated to maintain the average flow rate 72 and to regulate the liquid temperature flowing from the faucet exit 29 at the operator desired temperature. As long as the operator continues to hold the start input switch 31 depressed maintaining the start input signal activated 101, the flow of liquid through the faucet exit 29 continues. This cycle allows the operator to prime or preheat the faucet components with elevated temperature liquid to insure the desired liquid temperature is dispensed in a subsequent dispensing cycle. Also, if the start timer exceeds the preset value, the positive-displacement flow meters will be actuated while the start input switch 31 remains depressed, activating the start input signal as shown in FIG. 18B, which will dispense liquid while the start input switch 31 is activated 243 or until the dispensed volume equals the dispensed volume 210.

If the start input switch 31 is de-activated before the start timer exceeds the preset value 241, the dispensing process continues as shown in FIG. 18B step 242, which dispenses liquid until the operator desired volume has been dispensed 210; or the start input switch 31 is activated 242. If the start input switch 31 signal is activated while liquid is flowing 242, the flow-restrictor apparatus are de-actuated which suspends liquid flowing through the corresponding flow meter and the faucet exit 29. When the operator depresses the start input switch 31 signal as shown in step 246, the liquid dispensing continues until the dispensed volume is dispensed 210 or the operator activates the On/Off input switch signal 240.

Now referring to FIG. 18B, the operator input stored volume of liquid to be dispensed is retrieved 201 from memory 36. The programmable controller 3 compares the volume to be dispensed to a predefined volume 82 to adjust the liquid flow rate based on the operator desired volume of liquid. If the dispensed volume is above the predefined volume, the flow-restrictor apparatus are actuated at a rate to dispense at a high flow rate. If the dispensed volume is below the predefined volume, the flow-restrictor apparatus are actuated at a rate to dispense at a lower flow rate as shown in step 83.

The accumulated total volume dispensed is stored in memory as shown in step 207. The temperature sensor 19 is read by the programmable controller 3 in step 205.

The current dispensed liquid temperature is compared to the desired operator input temperature in step 208. Each flow-restrictor apparatus is adjusted to achieve the desired flow rate through the corresponding flow meter based on the difference between the current temperature and desired temperature.

A table of frequently dispensed heated liquid volumes may be maintained in the memory 36. This table would include the predefined liquid volume and temperature. The operator input 2 will allow the operator to select a predefined volume and temperature of heated liquid for measured dispensing from the electronic kitchen dispensing faucet apparatus 1B. These frequently dispensed volumes and temperatures are typical of pre-packaged food products like instant soups, tea, coffee, cocoa, or other hot beverages. The table of volumes and temperatures may be preprogrammed from the manufacturer or input by the operator and stored in memory 36 for future use.

To use the table of frequently dispensed heated liquid volumes and temperatures, the operator input would enable the selection from the table of heated volumes and temperatures. The operator would then scroll through each entry stored in memory 36. When the desired table entry is located by the operator, the operator would then select this entry for subsequent dispensing when the start input switch 31 is activated.

Now referring to FIG. 17, the electronic kitchen dispensing faucet apparatus 1B may also include a manual mixing valve 8, a first and second flow meter 17 and 18 respectively for measuring the volume of the first and second source of liquids flowing through the faucet exit 29 as a result of the manual mixing valve actuation. The manual mixing valve 8 provides the means for the operator to infinitely adjust the flow rates of the first and second pressurized source liquids 15, 16 through the manual mixing valve 8 and to be dispensed from the faucet exit 29.

The first flow meter 17 inlet is in fluid connection with the first source of liquid 15 and the outlet being in fluid connection with the first inlet of the manual mixing valve 8. The second flow meter 18 inlet is in fluid connection with the second source of liquid 16 and the outlet is in fluid connection with the second inlet of the manual mixing valve 8. The manual mixing valve 8 outlet is in fluid connection with the liquid conduit connected to the outlet, temperature sensor 19, and faucet exit 29.

The first and second flow meters 17, 18 generate signals representative of the volume of liquid flowing through their respective flow meter, these signals are connected to the programmable controller 3 which sums the discrete volumes represented by each signal pulse and accumulating the total volume flowing of the first and second pressurized source liquid 15, 16 in its memory 36 for future processing.

The programmable controller 3 may display the accumulated volume of liquid flowing through the first and second flow meters 17, 18, and the average temperature dispensed from the faucet into a container on the display of the operator input 2 while the manual mixing valve 8 is actuated by the operator.

The operator can close the manual mixing valve 8, and using the operator input 2 select a total volume and temperature for dispensing by the electronic kitchen dispensing faucet apparatus 1B. The programmable controller 3 will calculate the remaining volume of liquid by subtracting the volume of liquid dispensed through the manual mixing valve from the desired volume selected from the operator input 2. The programmable controller 3 will then actuate the flow-restrictor apparatus to dispense the remaining volume of liquid from the faucet exit 29.

The programmable controller 3 may also sequence the flow-restrictor apparatus to complete the dispensing of liquid at the average temperature set by the operator using the manual mixing valve position. The programmable controller 3 may also sequence the flow-restrictor apparatus to complete the dispensing of liquid at the same flow rate established by the operator while operating the manual mixing valve 8.

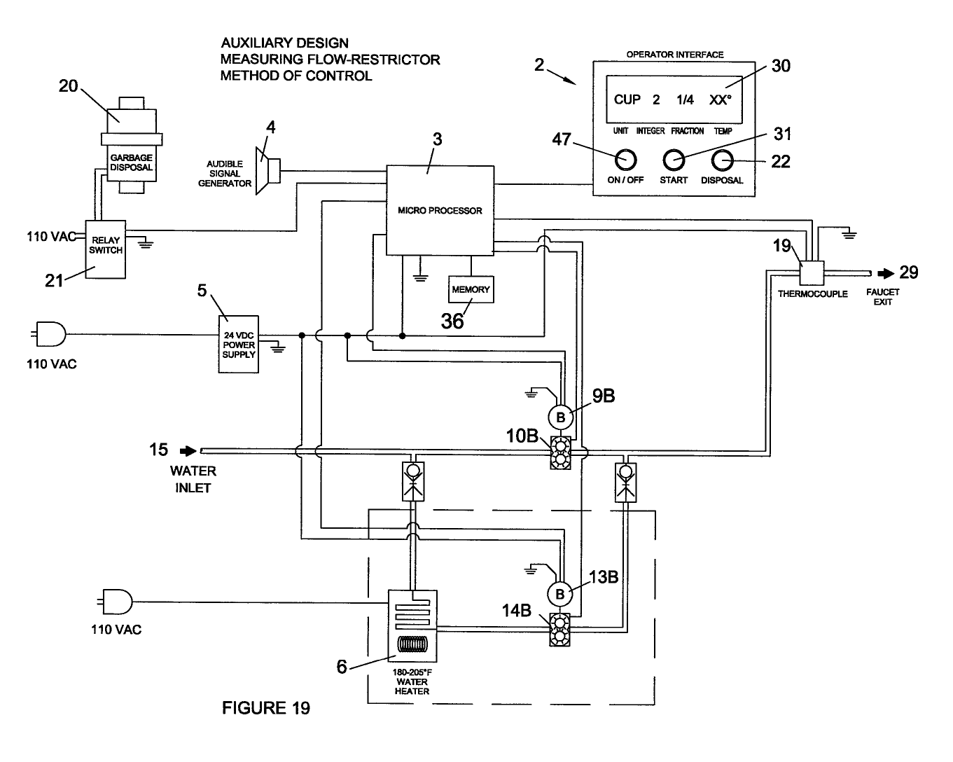

Referring to FIGS. 17 and 19, a garbage disposal input switch 22 may be connected to apparatus 1B (FIG. 17) as described above for apparatus 1 (FIG. 1).

Referring to FIG. 19, an Auxiliary-design electronic kitchen dispensing faucet 1B is shown with a first pressurized source liquid 15, a heating reservoir 6, a programmable controller 3, an operator input 2, a first flow-restrictor apparatus 9B, a first flow meter 10B, a temperature sensor 19B, a second flow-restrictor apparatus 13B, and a second flow meter 14B. The faucet shown dispenses an operator-defined volume of a first pressurized source liquid at an operator-defined temperature by activating the first flow-restrictor apparatus 9B controlling the rate of first pressurized source liquid flowing through the first flow meter 10B and the second flow-restrictor apparatus 13B controlling the rate of second pressurized source liquid flowing through the second flow meter 14B, measuring the volume and temperature of each liquid flowing through the faucet exit 29, and de-activating the flow-restrictor apparatus when the desired volume has been dispensed into the container 44.

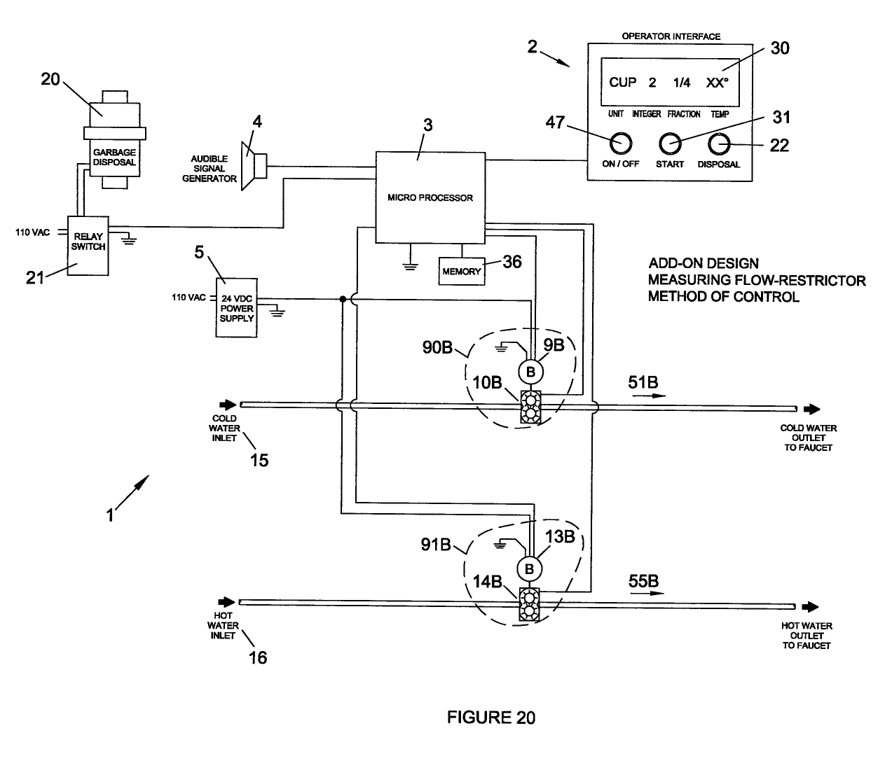

The Add-on electronic dispensing kitchen faucet shown in FIG. 20 may be used to retrofit a typical kitchen faucet and sink to allow dispensing of an operator-defined volume of liquid at an operator-specified temperature by activating the positive-displacement flow meters 10B and 14B. The plumbing modifications to the typical kitchen sink 45 are shown in FIG. 9.

Continuing to refer to FIG. 20, the electronic dispensing kitchen faucet apparatus for converting a typical kitchen faucet into a dispensing faucet includes a first circuit 90B, a second circuit 91B, a programmable controller 3, and an operator input 2. The first circuit 90B being adapted for connection between a first pressurized source liquid 15 to dispense liquid from the first source at a flow rate 51B and adapted for connection to the typical kitchen faucet cold water source inlet 15. The first circuit 90B includes a first flow-restrictor apparatus 9B and flow meter 10B for controlling the flow of the liquid from the first source through the first circuit 90B, and into the typical kitchen faucet cold water source inlet 15.

The second circuit 91B being adapted for connection between a second pressurized source liquid 16 to dispense liquid from the second source at a flow rate 55B and adapted for connection to the typical kitchen faucet hot water source inlet 16. The second circuit 91B includes a second flow-restrictor apparatus 13B and flow meter 14B for controlling the flow of the liquid from the second source through the second circuit 91B, and into the typical kitchen faucet hot water source inlet 16.

Continuing to refer to FIG. 20, the first flow meter 10B is allowed to operate freely when the electronic kitchen dispensing faucet is not dispensing a desired volume of liquid. The second flow meter 14B is also allowed to operate freely when the electronic kitchen dispensing faucet is not dispensing a desired volume of liquid.

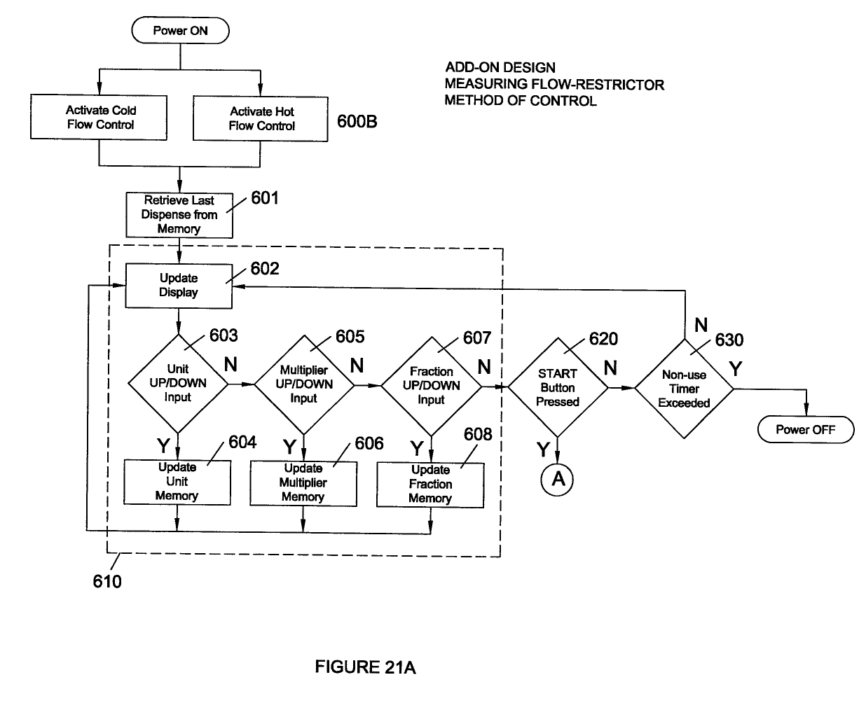

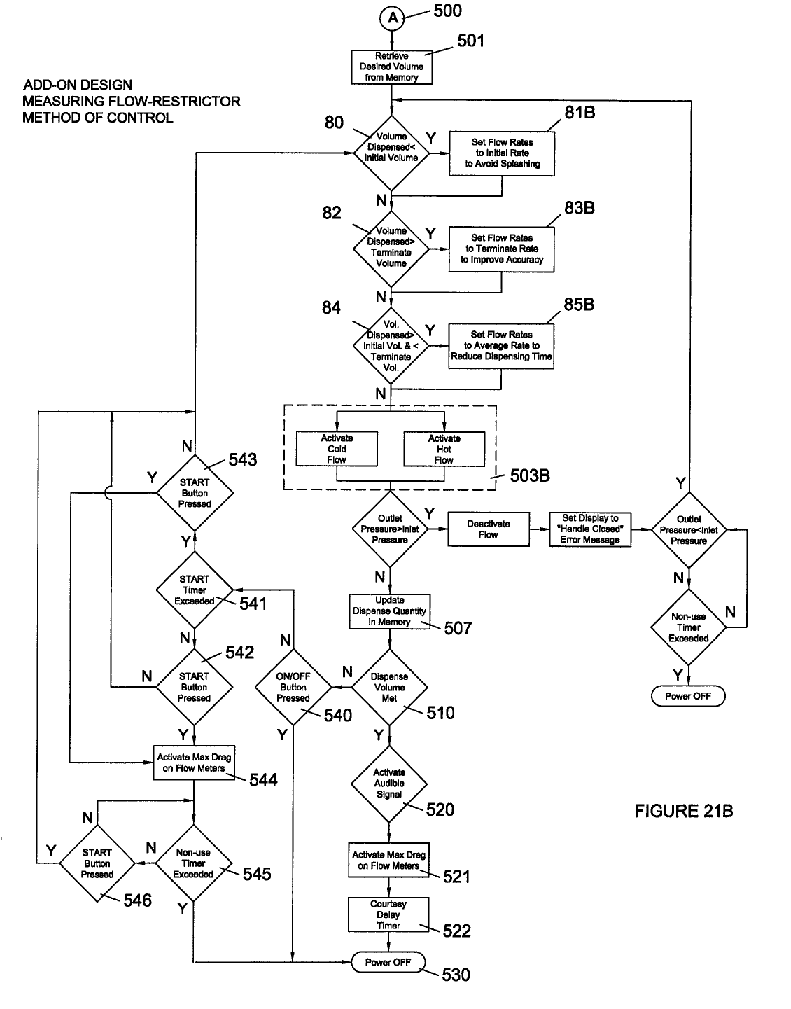

The programmable controller 3 generates output signals to control the first flow-restrictor apparatus 9B connected to the first flow meter 10B and the second flow-restrictor apparatus 13B connected to the second flow meter 14B. The operator input 2 includes an on/off input switch 47 which turns the electronic kitchen dispensing faucet on and off. When the on/off input switch 47 is depressed, the electronic kitchen faucet apparatus 1B is turned on. The first and second flow-restrictor apparatus are actuated as shown in FIG. 21A step 600B, terminating flow of the first and second liquid 15 and 16, respectively, through the faucet exit 29, thereby enabling the dispensing of an operator desired volume of liquid as shown in step 610. The programmable controller 3 generates an audible control signal which activates the audible signal generator 4 to inform the operator the electronic kitchen dispensing faucet apparatus 1B has completed dispensing the desired volume of liquid. This audible signal also indicates to the operator to close the manual mixing valve.

The programmable controller 3 may also generates an audible control signal which activates the audible signal generator 4 to inform the operator the electronic kitchen dispensing faucet apparatus 1B is monitoring the flow through the flow meters and is ready to control the flow-restrictor apparatus thereby controlling the flow rate and volume of liquid dispensed from the first and second pressurized source liquid through the faucet exit 29. The programmable controller 3 also displays a message to the operator on the operator display 30 indicating the operator must open the manual mixing valve to allow the measured volume of liquid to flow from the faucet exit 29.

When the start input switch is actuated as shown in FIG. 21A step 620, the desired volume of liquid is dispensed from the faucet exit 29. The programmable controller 3 calculates the rate of the flow-restrictor apparatus control signals needed to flow the desired volume of liquid desired by the operator.

If no activity occurs on the operator input within the non-use timer interval as shown in FIG. 21A step 630, the programmable controller 3 will generate an audible control signal to the audible signal generator 4 to inform the operator that the faucet apparatus 1B will be turned off. If the operator left the manual mixing valve in the open position, the first and second pressurized source liquids 15, 16 would flow through the faucet exit 29.

The operator input 2 allows the operator to select the desired volume of liquid to be dispensed as shown in FIG. 21A step 610.

The liquid flow rate through the faucet exit 29 is increased slowly to insure the liquid does not splash out of the container 44 or result in the containers ensuing mixture gushing out as the liquid begins to flow into the container 44. The programmable controller 3 locates the desired volume of liquid 75 within a flow rate table of volumes 70 (FIG. 11) stored in memory 36. The values for the initial, terminating, average, and maximum flow rates 71, 72, 73, 74, respectively, are extracted from the flow rate table 70 stored in memory 36. The initial, terminating, average, and maximum flow rates 71-74 are based on the dispensed volume 75 and the anticipated container size to be used in collecting the volume dispensed. The flow rate table 70 also contains the initial and terminating flow rate volumes 71 and 73, respectively. The initial flow rate 71 is used when the programmable controller 3 initiates liquid flowing through the faucet exit 29. The initial flow rate 71 will be allowed to flow for up to the initial flow volume before increasing the flow rate to the average flow rate 72. The terminating flow rate 73 is used when the dispensed volume is within the terminating flow volume. The flow rate will be reduced to the terminating flow rate 73 while dispensing the terminating flow volume and therefore dispense the total operator input volume desired.

Once the initial flow volume has been dispensed, the programmable controller 3 increases the liquid flow rate to the average flow rate 72. The programmable controller 3 generates control signals that activate the first flow-restrictor apparatus 9B connected to the first flow meter 10B and the second flow-restrictor apparatus 13B connected to the second flow meter 14B to maintain the flow rate at approximately the average flow rate 72; but below the maximum flow rate 74. The rate of flow through the flow meters 10B and 14B is controlled to maintain the liquid temperature at the desired operator temperature.

It should be recognized that the above-described embodiments of the invention are intended to be illustrative only. A latitude of modification, change, and substitution is intended in the foregoing disclosure, and in some instances, some features of the invention will be employed without a corresponding use of other features.

What is claimed is:

1. A liquid-dispensing apparatus comprising:
a fluid circuit and control system capable of automatically dispensing a prescribed quantity of water at a desired temperature and flow rate embodied;
a flow-controlling device for controlling the flow of liquid through the circuit;
a flow-measuring device, such as a flow meter or positive displacement pump, to measure the volume of liquid dispensed; and
a programmable controller operably connected to the flow-controlling device and flow-measuring device, the controller being programmed and adapted to receive first signals from the flow-measuring device and being programmed and adapted to generate a second control signal to operate the flow-controlling device to dispense an accurate amount of fluid at the desired flow rate and temperature.

2. The liquid-dispensing apparatus as defined in claim 1, including a base adapted for mounting to a kitchen sink, and a spout extending from the base for dispensing the total amount of liquid, with the fluid circuit being connected to the spout.

3. The liquid-dispensing apparatus as defined in claim 2, wherein the base supports an input device for inputting data into the controller.

4. The liquid-dispensing apparatus as defined in claim 2, wherein the flow-controlling device includes at least one on/off valve.

5. The liquid-dispensing apparatus as defined in claim 2, wherein the flow-controlling device includes a positive displacement pump.

6. The liquid-dispensing apparatus as defined in claim 2, wherein the flow-controlling device includes a variable-flow-restrictor device.

7. The liquid-dispensing apparatus as defined in claim 1, including a heat source, temperature sensor and separate flow-controlling device, and wherein the controller is connected to the sensor and flow-controlling device and is programmed to control the first and second flow-controlling devices to achieve a desired temperature.

8. The liquid-dispensing apparatus as defined in claim 1, including a base adapted for mounting to a kitchen sink alongside and in addition to an existing kitchen faucet, and a spout extending from the base for dispensing the total amount of liquid, with the fluid circuit being connected to the spout.

9. The liquid-dispensing apparatus as defined in claim 8, wherein the base supports an input device for inputting data into the controller.

10. The liquid-dispensing apparatus as defined in claim 1, including a control unit including the fluid circuit adapted to mount under the kitchen sink with the control unit output adapted to the input of an existing kitchen faucet.

11. The liquid-dispensing apparatus as defined in claim 10, wherein the input device for inputting data into the controller is a remote item operably connected to the control unit through wired, or wireless, technology and is adapted to be mounted discretely on a wall or countertop.
